(19) United States
(12) Patent Application Publication
(10) Pub. No.: US 2026/0219359 A1
(43) Pub. Date: Jul. 30, 2026

(54) MEMS MIRROR, MEMS MIRROR ARRAY, AND RADAR SYSTEM

(71) Applicant: BOE TECHNOLOGY GROUP CO., LTD., Beijing (CN)

(72) Inventors: Jianyun ZHAO, Beijing (CN); Jingwen GUO, Beijing (CN); Chunxin LI, Beijing (CN); Qianhong WU, Beijing (CN); Jianxing LIU, Beijing (CN); Zibo CAO, Beijing (CN); Ying DING, Beijing (CN)

(21) Appl. No.: 19/148,353

(22) PCT Filed: Jun. 12, 2024
(86) PCT No.: PCT/CN2024/098782

§ 371 Date: Jul. 16, 2025

(30) Foreign Application Priority Data
Jul. 27, 2023 (CN) 202310928124.5

(51) Int. Cl. G01S 7/03

(52) U.S. Cl. CPC G01S 7/03

(57) ABSTRACT

Embodiments of the present disclosure provide an MEMS mirror, an MEMS mirror array, and a radar system. The MEMS mirror comprises: an outer frame, wherein the outer frame is of a hollow structure; a rotating structure, wherein the rotating structure is located in a hollow area of the outer frame, the rotating structure comprises a reflecting mirror frame and a pair of rotating shafts connected between the reflecting mirror frame and the outer frame, and the reflecting mirror frame comprises a grounding electrode; a reflecting mirror, located on the reflecting mirror frame; a base, wherein the base and the outer frame form a cavity; and a steering electrode group, located on the side of the base facing the rotating structure, wherein the steering electrode group comprises a first steering electrode and a second steering electrode which are arranged on two sides of the pair of rotating shafts.

### CROSS REFERENCE TO RELATED APPLICATION

This application is a national phase entry under 35 U.S.C § 371 of International Application No. PCT/CN2024/098782, filed on Jun. 12, 2024, which claims priority to Chinese Patent Application No. 202310928124.5, filed with the China National Intellectual Property Administration on Jul. 27, 2023, and entitled “MEMS MIRROR, MEMS MIRROR ARRAY, AND RADAR SYSTEM”, the entire contents of which are incorporated by reference in their entireties.

### TECHNICAL FIELD

The present disclosure relates to the technical field of micro-electromechanical systems, and in particular to an MEMS vibrating mirror, an MEMS vibrating mirror array and a radar system.

### BACKGROUND

A Miciro-Electro-Mechanical System (MEMS) vibrating mirror is a tiny and drivable mirror made based on MEMS technologies, and its mirror diameter is usually only a few millimeters. Compared with traditional optical scanning mirrors, MEMS vibrating mirrors have the advantages of light weight, small size, easy mass production, and low production cost. The MEMS vibrating mirrors perform better in terms of optical, mechanical properties and power consumption. The MEMS vibrating mirrors are currently maturely used in markets such as LIDAR, high-definition projection, laser confocal microscopy systems, and AR. The movement modes of MEMS vibrating mirrors include two mechanical movements: translation and torsion. For torsional MEMS vibrating mirrors, when the optical deflection angle is large (reaching more than) 10°, laser pointing deflection, graphical scanning, and image scanning, etc., can be achieved.

### SUMMARY

Embodiments of the present disclosure provide an MEMS vibrating mirror, an MEMS vibrating mirror array and a radar system. The specific methods are as follows.

Embodiments of the present disclosure provide an MEMS vibrating mirror, including:
an outer frame, being a hollow structure;
a rotational structure, located in a hollow region of the outer frame, wherein the rotational structure includes a reflector frame and a pair of rotating shafts connected between the reflector frame and the outer frame, and the reflector frame includes a ground electrode;
a reflector, located on the reflector frame;
a substrate, wherein the substrate and the outer frame form a cavity; and
a steering electrode group, located on a side of the substrate facing the rotational structure, and the steering electrode group includes a first steering electrode and a second steering electrode arranged on both sides of the pair of rotating shafts; wherein,
when the ground electrode and the substrate are parallel, a distance between the first steering electrode and the ground electrode gradually decreases from outside to inside of the reflector, and a distance between the second steering electrode and the ground electrode gradually decreases from the outside to the inside of the reflector.

In one possible implementation, in the above MEMS vibrating mirror provided in the embodiments of the present disclosure, a surface of the substrate facing the reflector is a flat surface, and the first steering electrode and the second steering electrode each include at least two step structures with thicknesses gradually increasing from the outside to the inside of the reflector, and each of the step structures serves as a sub-electrode.

In one possible implementation, in the above MEMS vibrating mirror provided in the embodiments of the present disclosure, the substrate has at least two step structures with thicknesses gradually increasing from the outside to the inside of the reflector at a position of the substrate corresponding to each of the first steering electrode and the second steering electrode, and the first steering electrode and the second steering electrode are arranged on corresponding step structures.

In one possible implementation, in the above MEMS vibrating mirror provided in the embodiments of the present disclosure, a first included angle is formed between an inclined surface formed by each steering electrode and the substrate, a second included angle is formed between the reflector frame and the substrate after the reflector frame being rotated at a maximum angle, and a degree of the first included angle is smaller than a degree of the second included angle.

In one possible implementation, in the above MEMS vibrating mirror provided in the embodiments of the present disclosure, the ground electrode has, on a surface of the ground electrode facing the substrate, at least two step structures with thicknesses gradually increasing from the outside to the inside of the reflector at a position corresponding to each of the first steering electrode and the second steering electrode.

In one possible implementation, in the above MEMS vibrating mirror provided in the embodiments of the present disclosure, the first steering electrode and the second steering electrode each include sub-electrodes arranged corresponding to the step structures, and a thickness of each of the sub-electrodes is the same.

In one possible implementation, in the above MEMS vibrating mirror provided in the embodiments of the present disclosure, a gap is provided between every two adjacent sub-electrodes in each of the first steering electrode and the second steering electrode.

In one possible implementation, the above MEMS vibrating mirror provided in the embodiments of the present disclosure, further includes:
a first isolation layer, arranged on a side of the steering electrode group facing the ground electrode, wherein an orthographic projection of the first isolation layer on the substrate covers the substrate and the first isolation layer fills the gap.

In one possible implementation, in the above MEMS vibrating mirror provided in the embodiments of the present disclosure, a width of each of the step structures corresponding to the first steering electrode gradually increases from the outside to the inside of the reflector, and a width of each of the step structures corresponding to the second steering electrode gradually increases from the outside to the inside of the reflector.

In one possible implementation, in the above MEMS vibrating mirror provided in the embodiments of the present disclosure, the outer frame and the rotational structure are an integral structure formed using a silicon substrate, and the reflector frame is reused as the ground electrode.

In one possible implementation, in the above MEMS vibrating mirror provided in the embodiments of the present disclosure, the pair of rotating shafts are located on a same straight line and coincide with a central axis of the reflector, and the first steering electrode and the second steering electrode are symmetrically distributed on both sides of the central axis of the reflector.

In one possible implementation, in the above MEMS vibrating mirror provided in the embodiments of the present disclosure, a shape of the reflector is the same as a shape of the reflector frame, and a size of the reflector is the same as a size of the reflector frame.

In one possible implementation, in the above MEMS vibrating mirror provided in the embodiments of the present disclosure, the shape of the reflector includes a circle or an ellipse, and the rotating shafts are connected to an outer annular surface of the reflector frame.

In one possible implementation, in the above MEMS vibrating mirror provided in the embodiments of the present disclosure, the shape of the reflector is square, a pair of side edges of the reflector frame have a concave structure, and the rotating shafts are embedded in the concave structure and connected to the reflector frame.

In one possible implementation, the above MEMS vibrating mirror provided in the embodiments of the present disclosure, further includes:
a plurality of contact electrodes, arranged between the steering electrode group and the substrate and arranged in a one-to-one correspondence with the step structures,
a first driving structure, arranged between the contact electrodes and the substrate and corresponding to the first steering electrode, and
a second driving structure, arranged between the contact electrodes and the substrate and corresponding to the second steering electrode; wherein,
the first steering electrode is electrically connected to contact electrodes corresponding to the first steering electrode, and the second steering electrode is electrically connected to contact electrodes corresponding to the second steering electrode;
the contact electrodes corresponding to the first steering electrode are electrically connected to the first driving structure, and the contact electrodes corresponding to the second steering electrode are electrically connected to the second driving structure.

In one possible implementation, in the above MEMS vibrating mirror provided in the embodiments of the present disclosure,
the first driving structure includes: a first driving electrode electrically connected to all of the contact electrodes corresponding to the first steering electrodes, and a first driving line electrically connected to the first driving electrode;
the second driving structure includes: a second driving electrode electrically connected to all of the contact electrodes corresponding to the second steering electrodes, and a second driving line electrically connected to the second driving electrode.

In one possible implementation, in the above MEMS vibrating mirror provided in the embodiments of the present disclosure,
the first driving structure includes: first driving electrodes electrically connected, in a one-to-one correspondence, to the contact electrodes corresponding to the first steering electrode, and first driving lines electrically connected to the first driving electrodes in a one-to-one correspondence;
the second driving structure includes: second driving electrodes electrically connected, in a one-to-one correspondence, to the contact electrodes corresponding to the second steering electrode, and second driving lines electrically connected to the second driving electrodes in a one-to-one correspondence.

In one possible implementation, the above MEMS vibrating mirror provided in the embodiments of the present disclosure, further includes:
a second isolation layer, arranged between the contact electrodes and the first driving structure, and between the contact electrodes and the second driving structure, and
a third isolation layer, arranged between the contact electrodes and the steering electrode group;
wherein the second isolation layer exposes the first driving electrodes and the second driving electrodes, and the third isolation layer exposes the contact electrodes.

Correspondingly, embodiments of the present disclosure further provide an MEMS vibrating mirror array, including a plurality of MEMS vibrating mirrors provided in the above embodiments of the present disclosure arranged in an array.

In one possible implementation, in the above MEMS vibrating mirror provided in the embodiments of the present disclosure, the first steering electrode in each of the MEMS vibrating mirrors corresponds to one first driving line or a plurality of first driving lines which are the same number as the step structures, the second steering electrode in each of the MEMS vibrating mirrors corresponds to one second driving line or a plurality of second driving lines which are the same number as the step structures, each first driving line in each of the MEMS vibrating mirrors is electrically connected to a same first driving voltage terminal, and each second driving line in each of the MEMS vibrating mirrors is electrically connected to a same second driving voltage terminal.

In one possible implementation, in the above MEMS vibrating mirror provided in the embodiments of the present disclosure, the first steering electrode in each of the MEMS vibrating mirrors corresponds to a plurality of first driving lines which are the same number as the step structures, and the second steering electrode in each of the MEMS vibrating mirrors corresponds to a plurality of second driving lines which are the same number as the step structures; wherein,
first driving lines corresponding to step structures at same positions in the respective MEMS vibrating mirrors are electrically connected to a same first driving voltage terminal, and first driving lines corresponding to step structures at different positions in the respective MEMS vibrating mirrors are electrically connected to different first driving voltage terminals;
second driving lines corresponding to step structures at same positions in the respective MEMS vibrating mirrors are electrically connected to a same second driving voltage terminal, and second driving lines corresponding to step structures at different positions in the respective MEMS vibrating mirrors are electrically connected to different second driving voltage terminals.

Correspondingly, embodiments of the present disclosure provide a radar system, including the above MEMS vibrating mirror provided in the embodiments of the present disclosure, or including the above MEMS vibrating mirror array provided in the embodiments of the present disclosure.

### BRIEF DESCRIPTION OF FIGURES

FIG. 1 is a schematic diagram of a transmitting and receiving system corresponding to a conventional MEMS vibrating mirror array applied to a laser radar.

FIG. 2 is a schematic structural diagram of an MEMS vibrating mirror provided in embodiments of the present disclosure.

FIG. 3 is a schematic plan view corresponding to FIG. 2.

FIG. 4 is an exploded schematic diagram of a structure of each layer corresponding to FIG. 2.

FIG. 5 is a schematic cross-sectional view of a portion of a structure along the AA′ direction in FIG. 3.

FIG. 6 is a schematic diagram of a deflection effect of driving the MEMS vibrating mirror when an AC voltage is applied to a first steering electrode shown in FIG. 5.

FIG. 7 is a schematic diagram of a deflection effect of driving the MEMS vibrating mirror when an AC voltage is applied to a second steering electrode shown in FIG. 5.

FIG. 8 is a diagram showing a partial circuit connection structure in FIG. 4.

FIG. 9 is a diagram showing a partial circuit connection structure in FIG. 4.

FIG. 10A-10F are schematic diagrams of a manufacturing process flow of the MEMS vibrating mirror shown in FIG. 2 provided in embodiments of the present disclosure.

FIG. 11 is a schematic structural diagram of another MEMS vibrating mirror provided in embodiments of the present disclosure.

FIG. 12 is a schematic plan view corresponding to FIG. 11.

FIG. 13 is an exploded schematic diagram of a structure of each layer corresponding to FIG. 11.

FIG. 14 is a schematic cross-sectional view of a portion of the structure along the AA′ direction in FIG. 12.

FIG. 15 is a schematic diagram of a deflection effect of driving the MEMS vibrating mirror when an AC voltage is applied to a first steering electrode in FIG. 14.

FIG. 16 is a schematic diagram of a deflection effect of driving the MEMS vibrating mirror when an AC voltage is applied to a second steering electrode in FIG. 14.

FIG. 17 is a schematic structural diagram of another MEMS vibrating mirror provided in embodiments of the present disclosure.

FIG. 18 is a schematic plan view corresponding to FIG. 17.

FIG. 19 is an exploded schematic diagram of a structure of each layer corresponding to FIG. 17.

FIG. 20 is a schematic cross-sectional view of a portion of the structure along the AA′ direction in FIG. 18.

FIG. 21 is a schematic cross-sectional view of a portion of the structure along the AA′ direction after the first isolation layer is provided in FIG. 13.

FIG. 22A-22B are schematic diagrams of a process flow for manufacturing the MEMS vibrating mirror shown in FIG. 17.

FIG. 23 is a schematic diagram of a structure of another MEMS vibrating mirror provided in embodiments of the present disclosure.

FIG. 24 is a schematic plan view corresponding to FIG. 23.

FIG. 25 is an exploded schematic diagram of a structure of each layer corresponding to FIG. 23.

FIG. 26 is a diagram showing a partial circuit connection structure in FIG. 25.

FIG. 27 is a diagram showing a partial circuit connection structure in FIG. 25.

FIG. 28A-28G are schematic diagrams of a manufacturing process flow of the MEMS vibrating mirror shown in FIG. 23.

FIG. 29 is an exploded schematic diagram of a structure of each layer of another MEMS vibrating mirror provided in embodiments of the present disclosure.

FIG. 30 is a diagram showing a partial circuit connection structure in FIG. 29.

FIG. 31 is a diagram showing a partial circuit connection structure in FIG. 29.

FIG. 32 is a schematic cross-sectional view of a portion of the structure in FIG. 29.

FIG. 33 is a schematic diagram of a structure of another MEMS vibrating mirror provided in embodiments of the present disclosure.

FIG. 34 is a schematic diagram of a structure of another MEMS vibrating mirror provided in embodiments of the present disclosure.

FIG. 35 is a schematic diagram of a structure of an MEMS vibrating mirror array provided in embodiments of the present disclosure.

FIG. 36 is a schematic diagram of a corresponding transmitting and receiving system when an MEMS vibrating mirror array provided in embodiments of the present disclosure is applied to a laser radar.

FIG. 37A-37D are schematic diagrams of a manufacturing process flow of the MEMS vibrating mirror array shown in FIG. 35.

### DETAILED DESCRIPTION

In order to make the purpose, technical solution and advantages of the embodiments of the present disclosure clearer, the technical solution of the embodiments of the present disclosure will be clearly and completely described below in conjunction with the drawings of the embodiments of the present disclosure. Obviously, the described embodiments are part of the embodiments of the present disclosure, not all of the embodiments. And in the absence of conflict, the embodiments in the present disclosure and the features in the embodiments can be combined with each other. Based on the described embodiments of the present disclosure, all other embodiments obtained by ordinary technicians in the field without creative work are within the scope of protection of the present disclosure.

Unless otherwise defined, the technical terms or scientific terms used in the present disclosure should be understood by people with ordinary skills in the field to which the present disclosure belongs. “Include” or “comprising” and other similar words used in the present disclosure mean that the elements or objects appearing before the word include the elements or objects listed after the word and their equivalents, without excluding other elements or objects. “Connect” or “couple” and other similar words are not limited to physical or mechanical connections, but may include electrical connections, whether direct or indirect. “Inside”, “outside”, “upper”, “lower”, etc., are only used to indicate relative positional relationships. When the absolute position of the described object changes, the relative positional relationship may also change accordingly.

It should be noted that the sizes and shapes of the figures in the accompanying drawings do not reflect the actual proportions, and are only intended to illustrate the present disclosure. The same or similar reference numerals throughout represent the same or similar elements or elements having the same or similar functions.

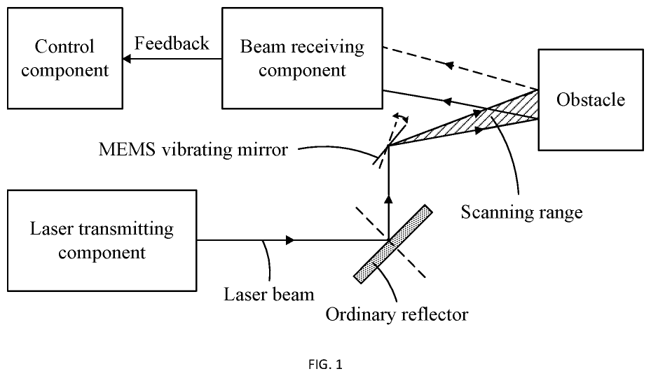

The mirror diameter of an MEMS vibrating mirror is usually only a few millimeters. It is a tiny and drivable reflector made based on MEMS technologies. Compared with traditional optical scanning mirrors, the MEMS vibrating mirror has superior performance such as small size, low power consumption, and high integration. It is currently mainly used in laser radar and other fields. As shown in FIG. 1, FIG. 1 is a schematic diagram of a corresponding transmitting and receiving system when a conventional MEMS vibrating mirror array is applied to a laser radar. The laser emitted by a laser transmitting component is reflected to nearby objects (obstacles) through ordinary reflectors and MEMS vibrating mirrors in turn, and is fed back to a control component according to the process shown in FIG. 1. The laser beam can be scanned by twisting the MEMS vibrating mirror at a small angle, and an image signal of the surrounding environment is obtained by processing the changes in the beam information fed back. Compared with traditional optical scanning mirrors, MEMS vibrating mirrors obtained by micromachining technologies are gradually replacing traditional optical scanning mirrors for laser radar and other fields because of their advantages such as light weight, small size, easy mass production, and low production cost, etc.

At present, the most widely used MEMS vibrating mirror is driven by a flat electrode. It has a simple structure and low processing difficulty, but it requires a large driving voltage to produce adsorption through the electrostatic force between the flat electrodes, and it is easy to attract. Although the electrostatic force can be increased by reducing the distance between the flat electrodes, it will also limit the available angle range of the MEMS vibrating mirror.

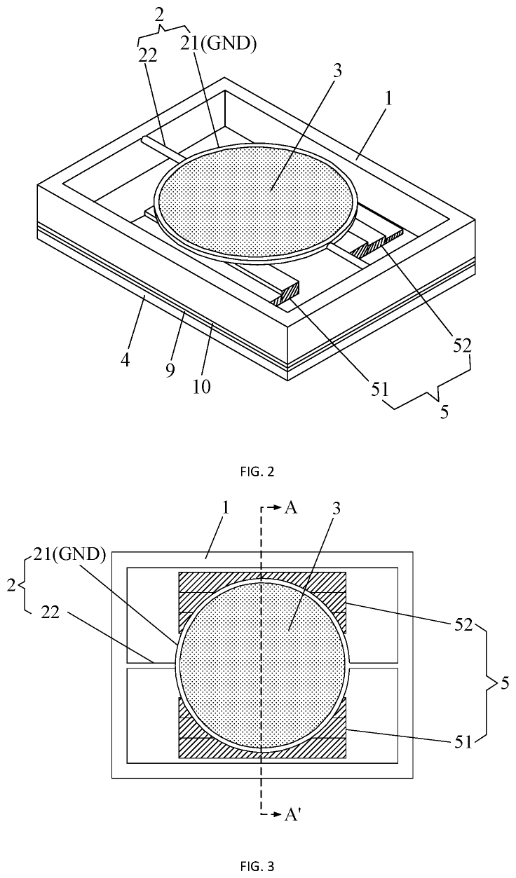

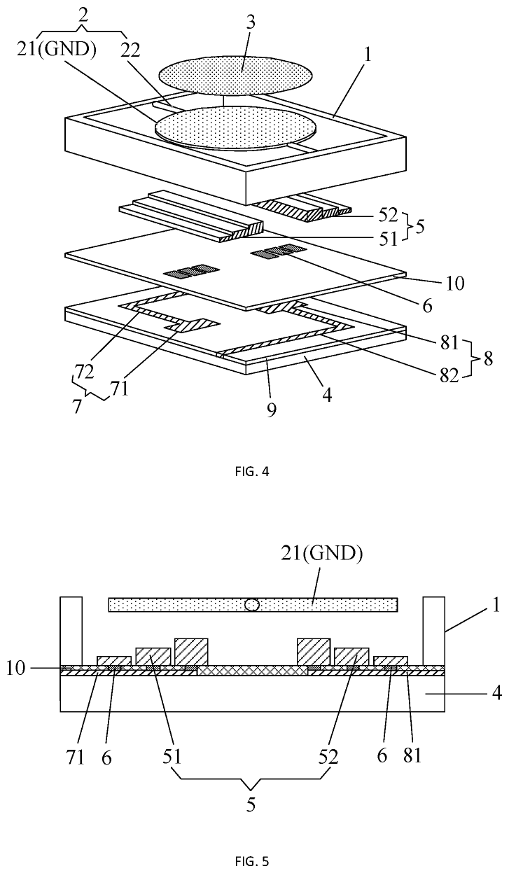

Embodiments of the present disclosure provide an MEMS vibrating mirror, as shown in FIGS. 2 to 5. FIG. 2 is a schematic diagram of a structure of the MEMS vibrating mirror. FIG. 3 is a plan schematic diagram corresponding to FIG. 2. FIG. 4 is an exploded schematic diagram of a structure of each layer corresponding to FIG. 2. FIG. 5 is a cross-sectional schematic diagram of a part of the structure along the AA′ direction in FIG. 3. The MEMS vibrating mirror includes:
an outer frame 1, which is a hollow structure; specifically, the outer frame 1 mainly plays a supporting role;
a rotational structure 2, located in a hollow region of the outer frame 1; wherein the rotational structure 2 can use the hollow region of the outer frame 1 to deflect, thereby realizing the deflection of the light beam; the rotational structure 2 includes a reflector frame 21 and a pair of rotating shafts 22 connected between the reflector frame 21 and the outer frame 1, that is, one end of the rotating shaft 22 is fixed to the outer frame 1, and the other end of the rotating shaft 22 is fixed to the reflector frame 21; the reflector frame 21 includes a ground electrode GND;
a reflector 3, located on the reflector frame 21; specifically, the reflector 3 deflects in the same manner as the reflector frame 21 deflects, and the reflector 3 can reflect the laser beam emitted by a laser emitting component and project the laser beam into a corresponding scanning region;
a substrate 4, wherein the substrate 4 and the outer frame 1 form a cavity; and
a steering electrode group 5, located on a side of the substrate 4 facing the rotational structure 2, and the steering electrode group 5 includes a first steering electrode 51 and a second steering electrode 52 arranged on both sides of the pair of rotating shafts 22; specifically, a ground voltage is applied to the ground electrode GND, and an AC voltage (driving voltage) is applied to the first steering electrode 51 or the second steering electrode 52, and the reflector frame 21 and the reflector 3 are driven to deflect in a preset direction around the rotating shaft 22 through an electrostatic adsorption force generated between the ground electrode GND and the first steering electrode 51 or between the ground electrode GND and the second steering electrode 52.

When the ground electrode GND is parallel to the substrate 1, a distance between the first steering electrode 51 and the ground electrode GND gradually decreases from the outside to the inside of the reflector 3, and a distance between the second steering electrode 52 and the ground electrode GND gradually decreases from the outside to the inside of the reflector 3.

In the above MEMS vibrating mirror provided by the embodiments of the present disclosure, when the ground electrode and the substrate are parallel, by setting the distance between the first steering electrode and the ground electrode to gradually decrease from the outside to the inside of the reflector, and setting the distance between the second steering electrode and the ground electrode to gradually decrease from the outside to the inside of the reflector, that is, the distance between the first steering electrode and the ground electrode and the distance between the second steering electrode and the ground electrode are set to change in a step-by-step manner. Since the smaller the distance between the first steering electrode and/or the second steering electrode and the ground electrode is, the greater the capacitance is, the greater the electrostatic adsorption force between the first steering electrode and/or the second steering electrode and the ground electrode is, the electrostatic adsorption force can be increased by reducing the spacing between the steering electrode group and the ground electrode without reducing the maximum torsion angle of the reflector. In this way, under the condition of the same electrostatic adsorption force, the present disclosure can reduce the driving voltage and reduce the power consumption. In addition, when the ground electrode is deflected, due to the step-by-step change in distance, there are more gaps between the ground electrode and the first steering electrode or the second steering electrode, which is conducive to reducing the adhesion between the ground electrode and the first steering electrode or the second steering electrode, thereby reducing the probability of the attraction phenomenon.

Optionally, the reflector 3 can be made of a metal material, or other materials capable of forming reflection.

In specific implementations, in the above MEMS vibrating mirror provided in the embodiments of the present disclosure, as shown in FIGS. 2 to 4, the outer frame 1 and the rotational structure 2 can be an integral structure formed by using a silicon substrate. Since the silicon substrate is a semiconductor, the reflector frame 21 of the rotational structure 2 can be directly reused as the ground electrode GND. Specifically, the vibrating mirror based on the MEMS process provided in the embodiments of the present disclosure can form the outer frame 1 for fixing the rotational structure 2 while forming the rotational structure 2, so that the outer frame 1 is used to fix the rotational structure 2 and other main structures of the MEMS vibrating mirror, which can increase the stability of the fixation and reduce the wear on the reflector 3 caused by the fixing process, thereby effectively improving the service life of the reflector 3.

Optionally, the silicon substrate can be made of single crystal silicon or polycrystalline silicon.

In specific implementations, in the present disclosure, the rotational structure 2 located in the hollow region of the outer frame 1 can be formed by etching the silicon substrate, or other processes, and the reflector 3 can be formed on the reflector frame 21 by deposition or sputtering, or other processes. The above preparation processes are all relatively mature operation steps in the MEMS process, and the embodiments of the present disclosure will not be described in detail.

Specifically, as shown in FIG. 2 to FIG. 5, the substrate 4 also adopts a silicon substrate, but is certainly not limited thereto.

In specific implementations, in the above MEMS vibrating mirror provided by the embodiments of the present disclosure, as shown in FIG. 2, FIG. 4 and FIG. 5, a surface of the substrate 4 facing the reflector 3 is a flat surface, and the first steering electrode 51 and the second steering electrode 52 each include at least two step structures with thicknesses gradually increasing from the outside to the inside of the reflector 3, and each of the step structures serves as a sub-electrode. Compared with a completely flat steering electrode structure in a conventional structure, the embodiments of the present disclosure improve the steering electrode group into a step structure with thicknesses gradually increasing from both sides to the middle, which can ensure that while the spacing between the first steering electrode 51 and the ground electrode GND and between the second steering electrode 52 and the ground electrode GND is reduced, the maximum torsion angle of the reflector 3 will not be reduced, and the electrostatic adsorption force between the electrodes can be increased. In this way, under the condition of the same electrostatic adsorption force, the present disclosure can reduce the driving voltage and reduce power consumption.

Specifically, electric field magnitudes formed between the first steering electrode 51 and the ground electrode GND and between the second steering electrode 52 and the ground electrode GND when a voltage is applied are calculated as follows:

$$E = \frac{1}{2} {CV}^{2} = \frac{ε {V}^{2}}{2 d} .$$

Electrostatic adsorption force magnitudes formed between the first steering electrode 51 and the ground electrode GND and between the second steering electrode 52 and the ground electrode GND are calculated as follows:

$$F = \frac{ε {SV}^{2}}{2 {d}^{2}} .$$

Here, E is an electric field, C is a capacitance, V is a voltage, ε is an dielectric constant, d is a distance between a step structure and a ground electrode, F is an electrostatic adsorption force, and S is a facing area between a ground electrode and a steering electrode. According to the above electrostatic adsorption force calculation formula, it can be known that when V is constant, a magnitude of the electrostatic adsorption force is inversely proportional to d, so the electrostatic strength can be enhanced by reducing d, and S is equivalent to the size of a projected overlapping area of the ground electrode and the steering electrode, which has nothing to do with the surface undulation of the steering electrode. Therefore, the overall appearance of the steering electrode group is designed to be a step structure with a certain inclination angle. Under the premise of not affecting the maximum torsion angle of the reflector, the distance between the first steering electrode 51 and the ground electrode GND and the distance between the second steering electrode 52 and the ground electrode GND can be significantly reduced, thereby reducing the driving voltage and reducing power consumption.

It should be noted that, in the embodiments of the present disclosure, the first steering electrode 51 and the second steering electrode 52 each include three step structures as an example. Of course, the first steering electrode 51 and the second steering electrode 52 may each include two step structures, or four or more step structures. As long as the step structures gradually increase in thickness from both sides to the middle of the reflector 3, they fall within the scope of protection of the embodiments of the present disclosure. The number of step structures in each steering electrode is designed according to actual needs.

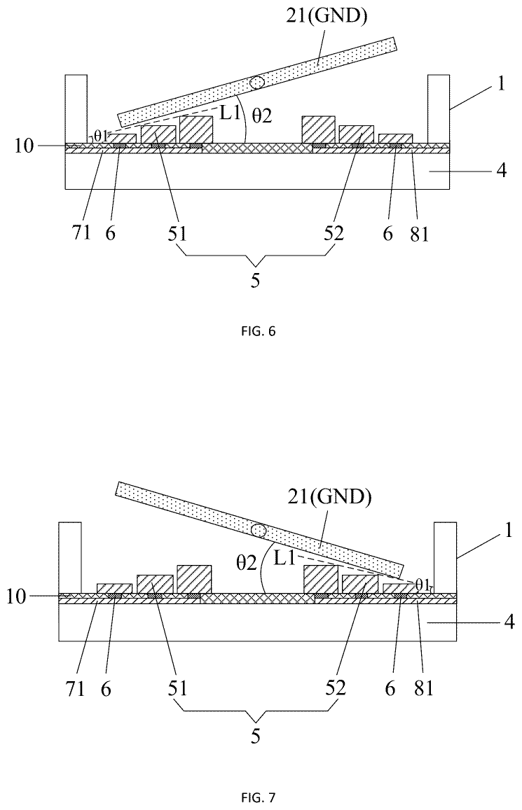

In specific implementations, in the above MEMS vibrating mirror provided in the embodiments of the present disclosure, as shown in FIG. 6 and FIG. 7, FIG. 6 is a schematic diagram of a deflection effect of driving the MEMS vibrating mirror when the first steering electrode 51 is loaded with an AC voltage, and FIG. 7 is a schematic diagram of a deflection effect of driving the MEMS vibrating mirror when the second steering electrode 52 is loaded with an AC voltage. A first included angle θ1 is formed between an inclined surface L1 formed by the first steering electrode 51 and the substrate 4, a first included angle θ1 is formed between an inclined surface L2 formed by the second steering electrode 52 and the substrate 4, and a second included angle θ2 is formed between the reflector frame 21 and the substrate 4 after the reflector frame 21 being rotated at the maximum angle, and a degree of the first included angle θ1 is smaller than a degree of the second included angle θ2. In this way, it can be ensured that while the spacing between the first steering electrode 51 and the ground electrode GND and the spacing between the second steering electrode 52 and the ground electrode GND are reduced, the maximum torsion angle of the reflector 3 will not be reduced. Therefore, the present disclosure will not limit the available angle range of the MEMS vibrating mirror, and thus will not limit the beam scanning range.

In specific implementations, in the above MEMS vibrating mirror provided in the embodiments of the present disclosure, as shown in FIG. 6, a gap is provided between every two adjacent sub-electrodes (step structures) in the first steering electrode 51 and the second steering electrode 52, that is, each sub-electrode in the first steering electrode 51 is spaced apart, and each sub-electrode in the second steering electrode 52 is spaced apart. In this way, when the reflector frame 21 deflects toward the side of the steering electrode, since there is a gap between every two adjacent step structures, and ideally only a vertical edge of the step structure is in contact with the ground electrode GND, the setting of the gap is beneficial to reduce the adhesion between the steering electrode and the ground electrode, thereby reducing the probability of the attraction phenomenon.

Optionally, as shown in FIG. 6, a gap width between step structures of different heights can be 6 μm to 10 μm, for example, the gap width can be 6 μm, 7 μm, 8 μm, 9 μm, 10 μm, etc.

In specific implementations, in the above MEMS vibrating mirror provided in the embodiments of the present disclosure, as shown in FIG. 2-FIG. 4, a pair of rotating shafts 22 are located on the same straight line and coincide with a central axis of the reflector 3, and the first steering electrode 51 and the second steering electrode 52 are symmetrically distributed on both sides of the central axis of the reflector 3. Specifically, the farther the sub-electrodes (step structures) in the steering electrode are from the central axis, the smaller the required driving voltage is, and vice versa, the larger the required driving voltage is. When the size of the ground electrode GND is fixed (that is, the size of the reflector frame 21 is fixed), when designing the step structure, it is necessary to ensure that the distance between the sub-electrodes and the central axis is not too large, resulting in a reduction in the electrode equivalent area.

In specific implementations, in the above MEMS vibrating mirror provided in the embodiments of the present disclosure, as shown in FIGS. 2 to 4, the shape of the reflector 3 is the same as the shape of the reflector frame 21, and the size of the reflector 3 is the same as the size of the reflector frame 21. It should be noted that the size of the reflector 3 and the size of the reflector frame 21 are the same, which means that they are roughly the same. There may be certain errors in actual production, for example, the size of the reflector 3 may be slightly smaller than the size of the reflector frame 21.

In specific implementations, in the above MEMS vibrating mirror provided in the embodiments of the present disclosure, as shown in FIGS. 2 to 4, the shape of the reflector 3 can be circular, and the rotating shaft 22 is connected to the outer annular surface of the reflector frame 21. Optionally, the shape of the reflector 3 can also be elliptical.

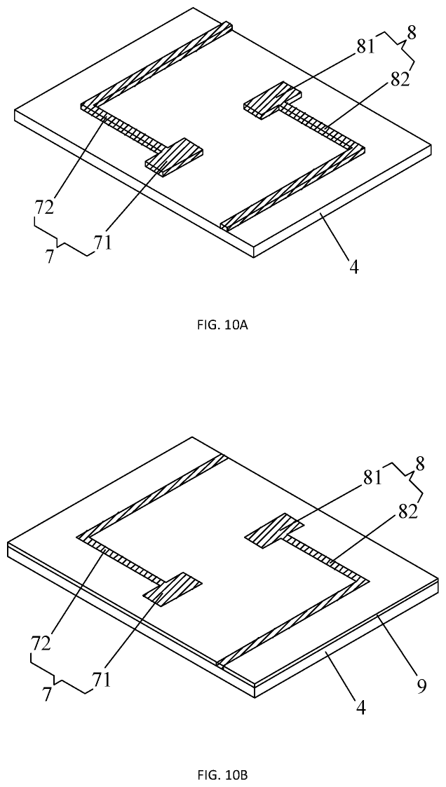

In specific implementations, in the above MEMS vibrating mirror provided in the embodiments of the present disclosure, as shown in FIGS. 4 to 9, FIG. 8 is a partial circuit connection structure diagram in FIG. 4, and FIG. 9 is a partial circuit connection structure diagram in FIG. 4. The MEMS vibrating mirror further includes: a plurality of contact electrodes 6 arranged between the steering electrode group 5 and the substrate 4 and arranged in a one-to-one correspondence with the step structures, a first driving structure(s) 7 arranged between the contact electrode(s) 6 and the substrate 4 and corresponding to the first steering electrode 51, and a second driving structure(s) 7 arranged between the contact electrode(s) 6 and the substrate 4 and corresponding to the second steering electrode 52.

The first steering electrode 51 is electrically connected to a corresponding one of the contact electrodes 6, and the second steering electrode 52 is electrically connected to a corresponding one of the contact electrodes 6.

A contact electrode(s) 6 corresponding to the first steering electrode(s) 51 is (are) electrically connected to the first driving structure(s) 7, and a contact electrode(s) 6 corresponding to the second steering electrode(s) 52 is (are) electrically connected to the second driving structure(s) 8. Specifically, the bottom of the first steering electrode 51 is interconnected with the first driving structure 7 through the contact electrode 6, and the bottom of the second steering electrode 52 is interconnected with the second driving structure 8 through the contact electrode 6. Since the gap between adjacent step structures is very small, according to the edge effect of the electric field, the first steering electrode 51 and the second steering electrode 52 can be equivalent to a complete electrode without a gap. When working, the first driving structure 7 applies a driving voltage to the first steering electrode 51 through the contact electrode 6, and the second driving structure 8 applies a driving voltage to the second steering electrode 52 through the contact electrode 6, and an electric field is formed between them and the ground electrode GND to generate an electrostatic adsorption force, so that the reflector 3 is deflected in a preset direction, and the reflector 3 can reflect the laser beam emitted by the laser emitting component and project the laser beam into the corresponding scanning region.

In specific implementations, in the above MEMS vibrating mirror provided in the embodiments of the present disclosure, as shown in FIG. 4 to FIG. 9, the first driving structure 7 includes: a first driving electrode 71 electrically connected to the contact electrode(s) 6 corresponding to the first steering electrode(s) 51 at the same time, and a first driving line 72 electrically connected to the first driving electrode 71.

The second driving structure 8 includes: a second driving electrode 81 electrically connected to the contact electrodes(s) 6 corresponding to the second steering electrode(s) 52 at the same time, and a second driving line 82 electrically connected to the second driving electrode 81. Specifically, in this embodiment, the respective contact electrodes 6 corresponding to the respective step structures of different thicknesses in the first steering electrode 51 are arranged to be electrically connected to the same first driving electrode 71, and the respective contact electrodes 6 corresponding to the respective step structures of different thicknesses in the second steering electrode 52 are arranged to be electrically connected to the same second driving electrode 72, that is, one driving structure connects all the step structures in the corresponding steering electrodes, so that the driving voltage is applied to all the step structures in the first steering electrode 51 through the first driving line 72, and the driving voltage is applied to all the step structures in the second steering electrode 52 through the second driving line 82, which can save the complexity of the driving structure design.

In specific implementations, in order to avoid short circuit between the contact electrode and the first driving structure, short circuit between the contact electrode and the second driving structure, and short circuit between the contact electrode and the steering electrode group, in the above MEMS vibrating mirror provided in the embodiments of the present disclosure, as shown in FIGS. 4-8, the MEMS vibrating mirror further includes: a second isolation layer 9 arranged between the contact electrode(s) 6 and the first driving structure(s) 7, and between the contact electrode(s) 6 and the second driving structure(s) 8, and a third isolation layer 10 arranged between the contact electrode(s) 6 and the steering electrode group 5; wherein the second isolation layer 9 exposes the first driving electrode(s) 71 and the second driving electrode(s) 81 to realize electrical connection between the first driving electrode(s) 71 and the second driving electrode(s) 81 and the corresponding contact electrode(s) 6 respectively; the third isolation layer 10 exposes the contact electrode(s) 6 to realize corresponding electrical connection between the contact electrode(s) 6 and the first steering electrode(s) 51 and the second steering electrode(s) 52.

Optionally, the materials of the second isolation layer 9 and the third isolation layer 10 include but are not limited to insulating materials such as SiNx.

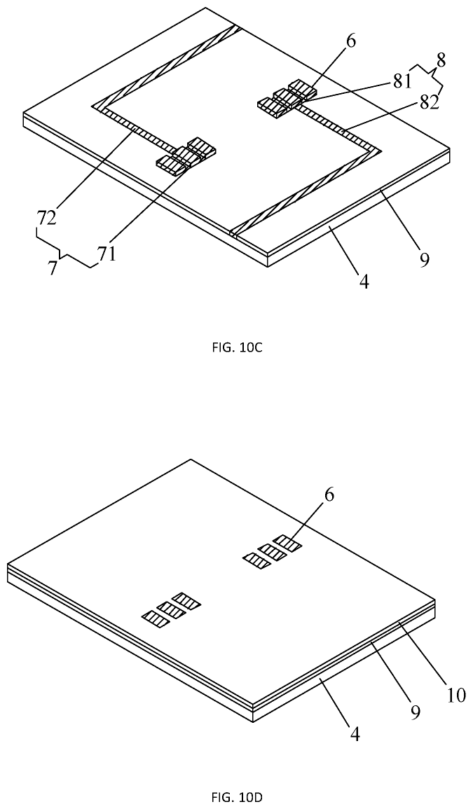

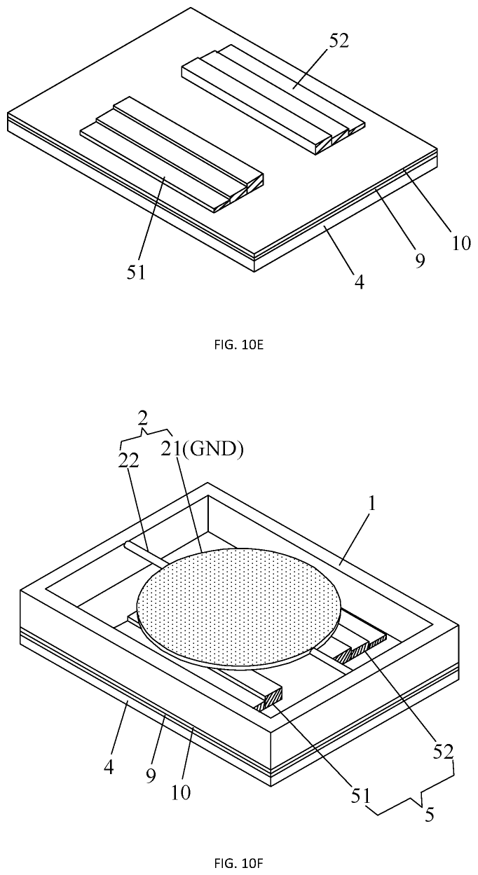

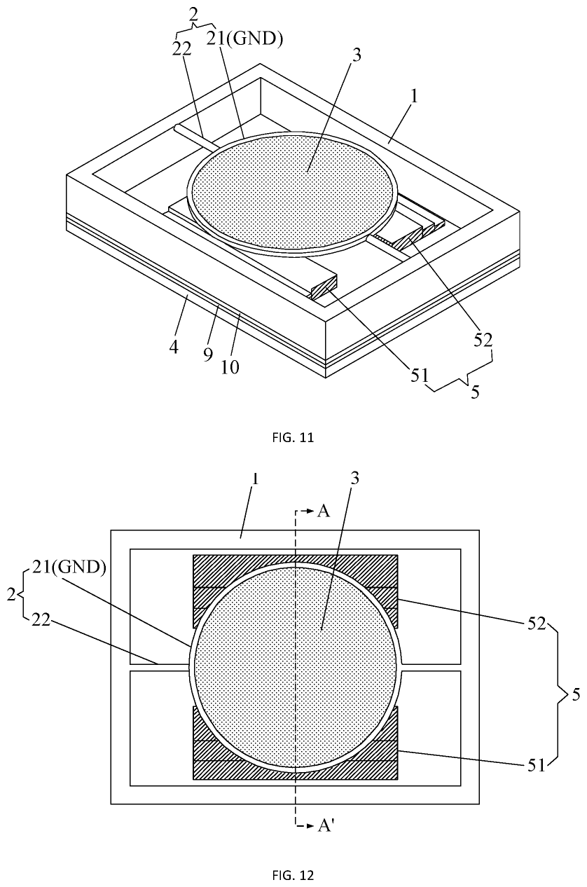

The following is an explanation of the manufacturing process of the MEMS vibrating mirror shown in FIG. 2 provided in the embodiments of the present disclosure. The specific steps of the manufacturing process are as follows.
1. A metal film layer (such as a Cu layer) is deposited on a substrate 4 (silicon substrate) by sputtering, and the metal film layer is patterned and etched to form a first driving structure 7 and a second driving structure 8, as shown in FIG. 10A.
2. A SiNx film layer is deposited on the first driving structure 7 and the second driving structure 8 by PECVD, and the SiNx film layer is patterned by ICP etching technology to expose the first driving electrode 71 and the second driving electrode 81 to form a second isolation layer 9, as shown in FIG. 10B.
3. A Cu layer is sputter-deposited on the second isolation layer 9 again, and the Cu layer is pattern-etched to form a plurality of contact electrodes 6 corresponding to the first driving electrode 71 and the second driving electrode 81, as shown in FIG. 10C.
4. A SiNx film layer is deposited again on the contact electrode 6 by PECVD, and the surface is planarized by chemical mechanical polishing (CMP) technology and the contact electrode 6 is exposed to form a third isolation layer 10, as shown in FIG. 10D.
5. A Cu layer is sputtered and deposited on the third isolation layer 10, photoresist is spin-coated, and a photoresist process is used to pattern and etch the Cu layer to form conductive structures in a one-to-one correspondence with the contact electrodes 6. Repeat the steps of depositing the Cu layer, spin-coating the photoresist, and patterning the Cu layer to form a stepped first steering electrode 51 and a stepped second steering electrode 52 with a certain height difference, as shown in FIG. 10E.
6. Etch an outer frame 1 and a rotational structure 2 on another silicon substrate by ICP etching technology. A reflector frame 21 of the rotational structure 2 is reused as a ground electrode GND. The substrate 4 and the outer frame 1 are bonded together, as shown in FIG. 10F.
7. Spin-coat photoresist (sacrificial layer) to fill a hollow region of FIG. 10F, then coat a surface of the reflector frame 21 with a reflective material to form a reflector 3, and after removing the sacrificial layer, the MEMS vibrating mirror shown in FIG. 2 provided in embodiments of the present disclosure is obtained.

In summary, the MEMS vibrating mirror shown in FIG. 2 provided by the embodiments of the present disclosure has at least the following advantages.
1. The MEMS vibrating mirror structure designed in the present disclosure is not complicated in design and can be manufactured using existing semiconductor device manufacturing technology. The overall manufacturing process is relatively simple.
2. By replacing the conventional flat electrode structure with a stepped steering electrode, the distance between the steering electrode and the ground electrode can be reduced without reducing the maximum torsion angle of the vibrating mirror, thereby reducing the driving voltage and power consumption.
3. When the reflector frame deflects toward a side of the steering electrode, there is a gap between every two adjacent step structures, and ideally only the vertical edge of the step structure is in contact with the ground electrode. Therefore, the setting of the gap is beneficial to reduce the adhesion between the steering electrode and the ground electrode, thereby reducing the probability of the attraction phenomenon.

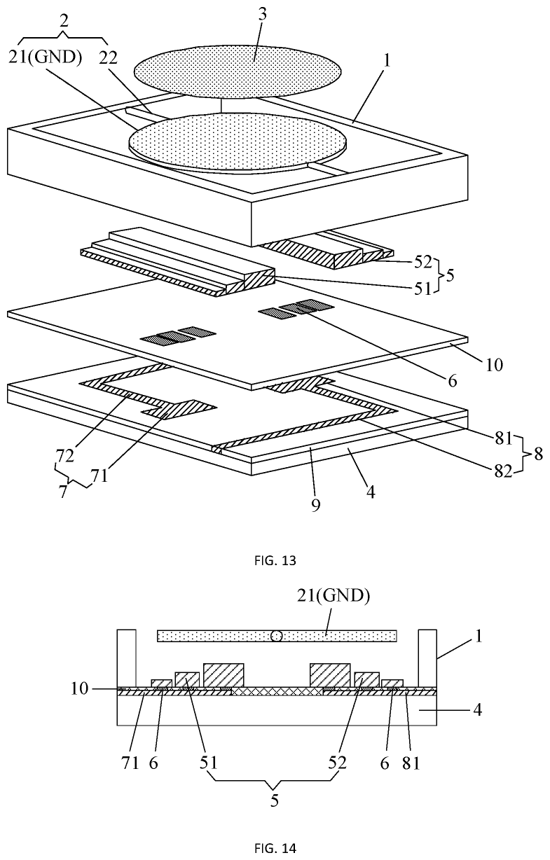

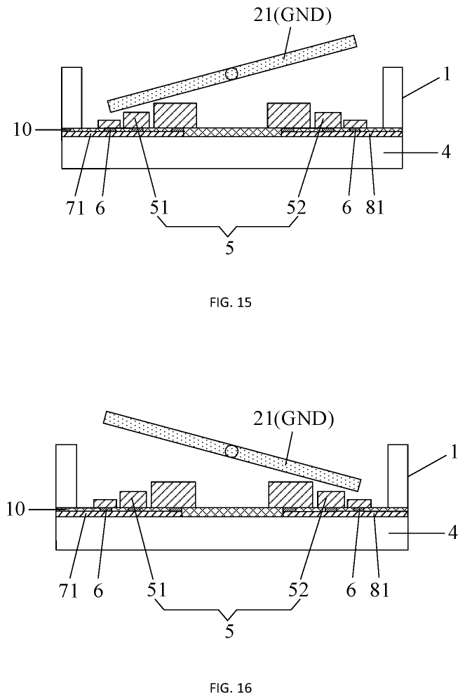

In specific implementations, in the above MEMS vibrating mirror provided in the embodiments of the present disclosure, as shown in FIGS. 11 to 16, FIG. 11 is another structural schematic diagram of the MEMS vibrating mirror, FIG. 12 is a plan schematic diagram corresponding to FIG. 11, FIG. 13 is an exploded schematic diagram of a structure of each layer corresponding to FIG. 11, FIG. 14 is a cross-sectional schematic diagram of part of the structure along the AA′ direction in FIG. 12, FIG. 15 is a schematic diagram of the deflection effect of driving the MEMS vibrating mirror when the first steering electrode 51 is loaded with an AC voltage, and FIG. 16 is a schematic diagram of the deflection effect of driving the MEMS vibrating mirror when the second steering electrode 52 is loaded with an AC voltage. The width of each step structure corresponding to the first steering electrode 51 gradually increases from the outside to the inside of the reflector 3, and the width of each step structure corresponding to the second steering electrode 52 gradually increases from the outside to the inside of the reflector 3. Specifically, the MEMS vibrating mirror shown in FIG. 13 of the embodiments of the present disclosure has no significant change in overall structure compared to the MEMS vibrating mirror shown in FIG. 4. Only the width of the step structures of different thicknesses in the stepped steering electrode is changed, and the design of the equal width of each step structure in FIG. 4 is changed to a design in which the width gradually increases from the outside to the inside of the reflector 3. The structural changes of FIG. 13 and FIG. 4 can be seen from the schematic diagrams of FIG. 14-FIG. 16 and FIG. 5-FIG. 7, the maximum torsion angle of the MEMS vibrating mirror remains unchanged, and the height difference, gap, overall width and position between the respective step structures of the stepped steering electrode have not changed. Only the step structures of different heights gradually widen from the outside to the inside of the reflector 3.

Specifically, as shown in FIGS. 11 to 14, when the reflector 3 is not rotated, the step structure with the smallest distance from the ground electrode GND is mainly driven. When the reflector 3 is rotated by a certain angle, the step structure with the largest distance from the ground electrode GND is mainly driven. Therefore, compared with the conventional MEMS vibrating mirror, the improvement of width gradient of the step structure of the MEMS vibrating mirror shown in FIGS. 11 to 14 in the embodiments can make the area of the step structure of the initial drive (when the reflector is not rotated) larger, and can provide a greater electrostatic adsorption force under the same driving voltage. When the reflector 3 is rotated by the electrostatic adsorption force, although the area of the step structure with the largest distance from the ground electrode is reduced, the rotated reflector 3 can compensate for the reduced electrostatic adsorption force through inertia.

Specifically, the other film layer structures and manufacturing processes in FIGS. 11-14 refer to the aforementioned description of the structures shown in FIGS. 2-5. The difference in the manufacturing process is only that the width gradient change is made when manufacturing the steering electrode group, which will not be repeated here.

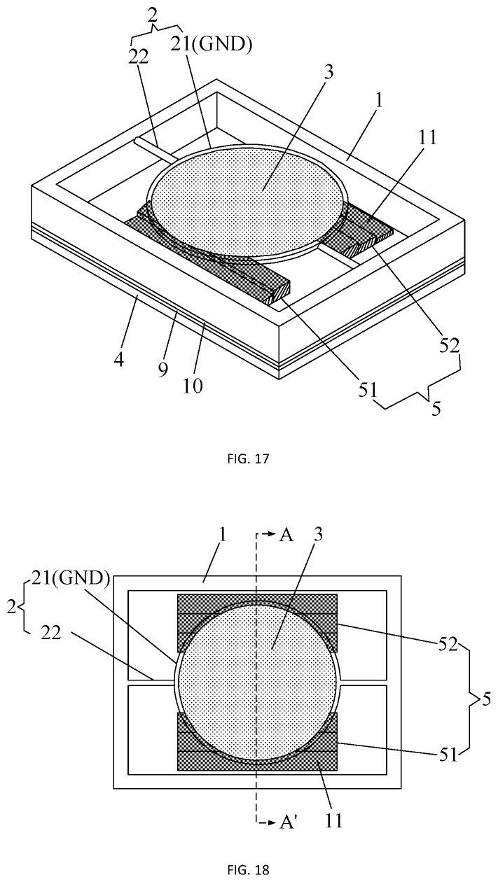

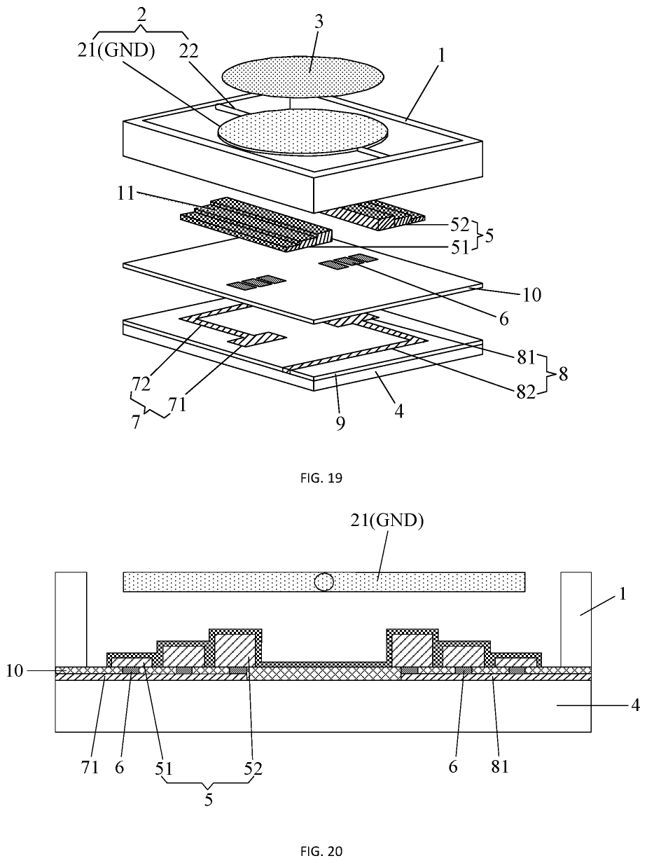

In specific implementations, when the MEMS vibrating mirror shown in FIG. 4 and FIG. 13 is working, during the deflection of the ground electrode GND toward the steering electrode, when the torsion angle is the largest, there may be a short circuit between the ground electrode GND and the steering electrode, which may cause a strong instantaneous current to break down the MEMS vibrating mirror and damage the MEMS vibrating mirror. Therefore, in the above MEMS vibrating mirror provided in the embodiments of the present disclosure, as shown in FIG. 17-FIG. 20, FIG. 17 is another structural schematic diagram of the MEMS vibrating mirror, FIG. 18 is a planar schematic diagram corresponding to FIG. 17, FIG. 19 is an exploded schematic diagram of a structure of each layer corresponding to FIG. 17, and FIG. 20 is a cross-sectional schematic diagram of a part of the structure along the AA′ direction in FIG. 18. The MEMS vibrating mirror further includes a first isolation layer 11 arranged on a side of the steering electrode group 5 facing the ground electrode GND, and an orthographic projection of the first isolation layer 11 on the substrate 4 covers the substrate 4 and the first isolation layer fills the gap. In this way, the first isolation layer 11 is added to cover the surface of the steering electrode group as an isolation layer during the process preparation process to protect the ground electrode GND and the steering electrode from short circuit when they are in contact.

Optionally, the material of the first isolation layer 11 includes but is not limited to insulating materials such as SiNx.

It should be noted that, during the deposition of SiNx, SiNx is filled in the gaps between the step structures of different depths. Since the gap width is less than 10 μm, it will not affect the edge effect of the steering electrode.

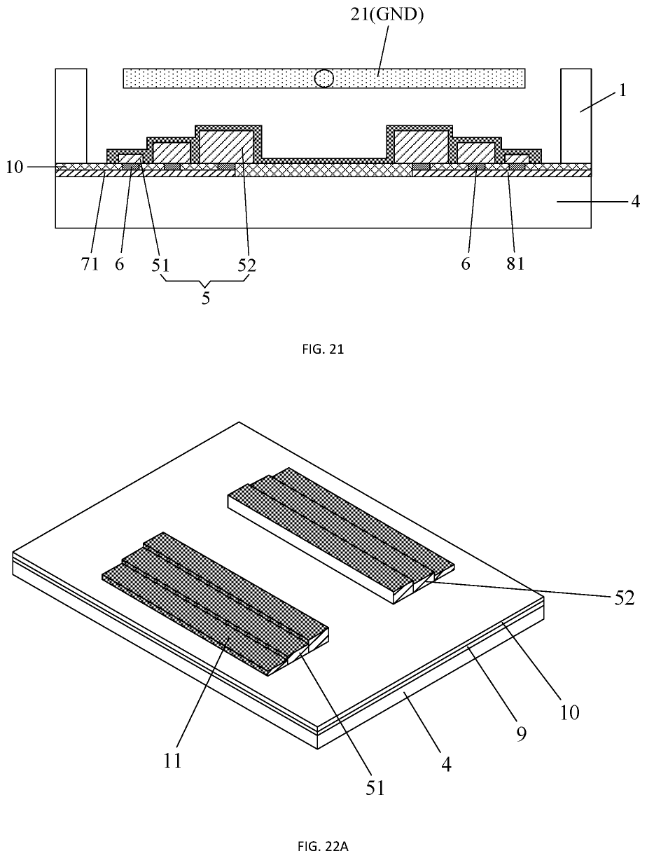

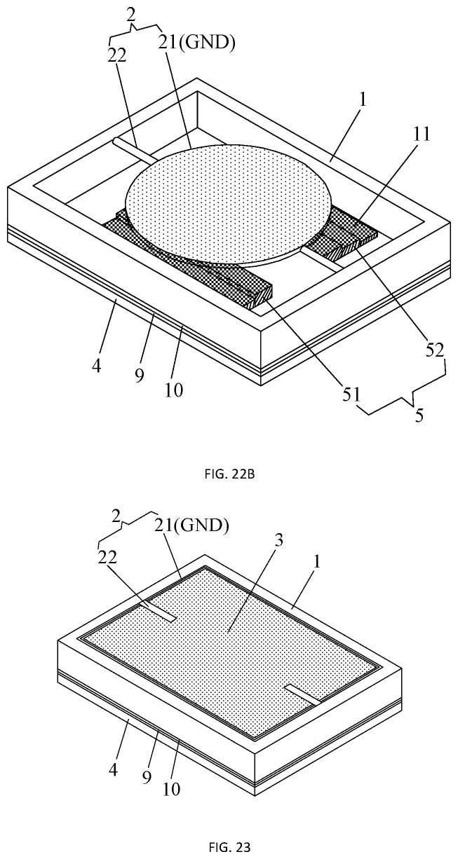

It should be noted that, FIGS. 17 to 20 are based on FIGS. 2 to 5, and a first isolation layer 11 is set on a side of the steering electrode group 5 facing the ground electrode GND; of course, a first isolation layer 11 can also be set on a side of the steering electrode group 5 facing the ground electrode GND on the basis of FIGS. 11 to 14, as shown in FIG. 21, FIG. 21 is a cross-sectional schematic diagram of the partial structure along the AA′ direction after the first isolation layer 11 is set in FIG. 13.

Specifically, the other film layer structures in FIGS. 17 to 21 refer to the aforementioned description of the structures shown in FIGS. 2 to 5, and will not be repeated here.

Specifically, the manufacturing process of the MEMS vibrating mirror shown in FIG. 17 differs from the manufacturing process of the MEMS vibrating mirror shown in FIG. 2 in that: after the stepped first steering electrode 51 and second steering electrode 52 are completed in step 5, materials such as SiNx can be deposited as the first isolation layer 11 by the PECVD process to cover the first steering electrode 51 and the second steering electrode 52, as shown in FIG. 22A. Afterwards, similar to step 6 and step 7 in the manufacturing process shown in FIG. 2, the corresponding structure after step 6 is shown in FIG. 22B, and the corresponding structure after step 7 is shown in FIG. 17. That is, FIG. 10A-FIG. 10E, FIG. 22A, FIG. 22B and FIG. 17 are process flow charts for manufacturing the MEMS vibrating mirror shown in FIG. 17.

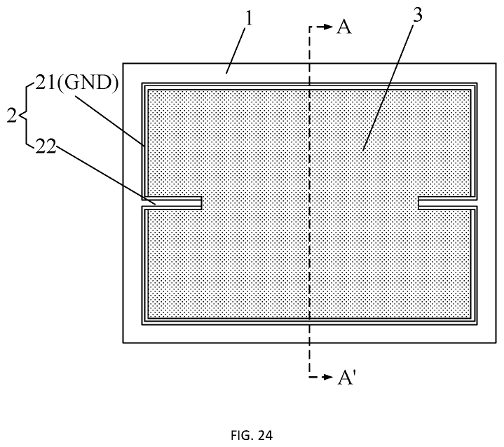

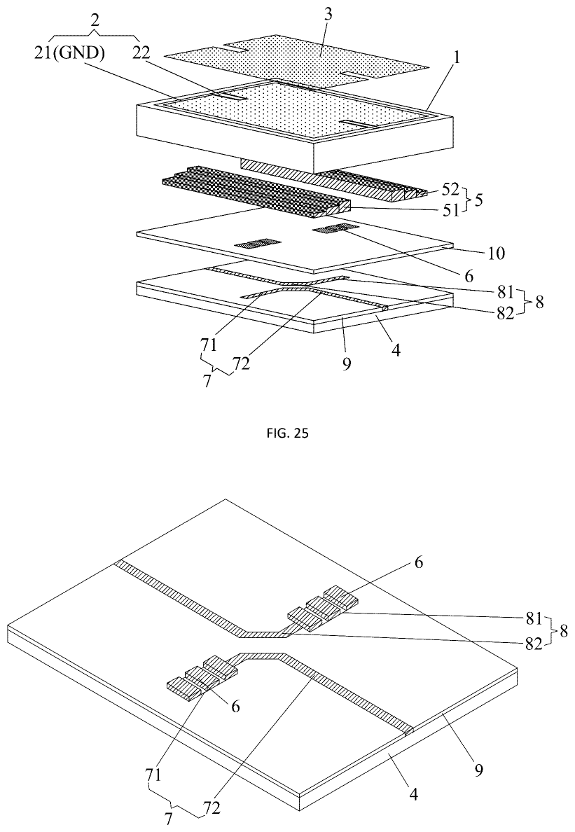

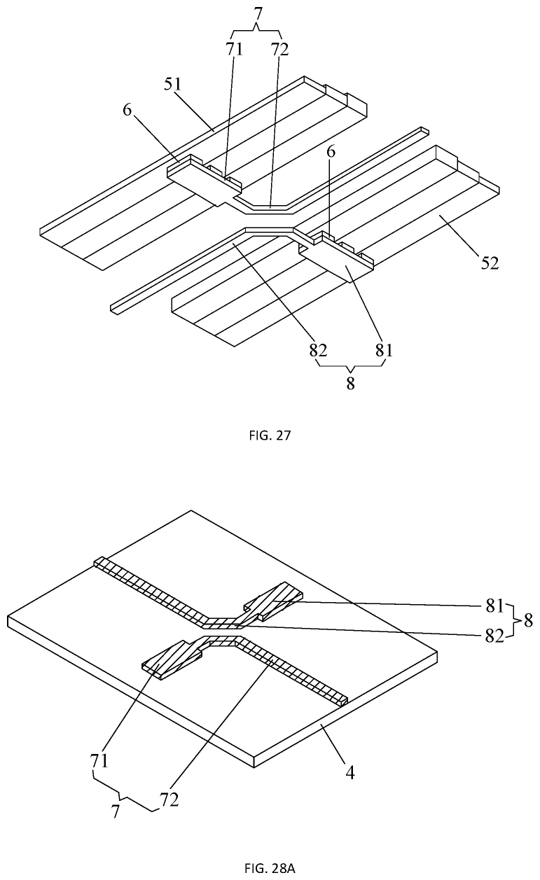

In specific implementations, when the MEMS vibrating mirror provided by the embodiments of the present disclosure is applied to a laser radar, in order to increase a scanning area of the laser radar, in the above MEMS vibrating mirror provided by the embodiments of the present disclosure, as shown in FIGS. 23-27, FIG. 23 is another structural schematic diagram of the MEMS vibrating mirror, FIG. 24 is a plane schematic diagram corresponding to FIG. 23, FIG. 25 is an exploded schematic diagram of a structure of each layer corresponding to FIG. 23, FIG. 26 is a partial circuit connection structure diagram in FIG. 25, and

FIG. 27 is a partial circuit connection structure diagram in FIG. 25. The shape of the reflector 3 can be square, and a pair of side edges of the reflector frame 21 have a concave structure, and the rotating shaft 22 is embedded in the concave structure and connected to the reflector frame 21. In this embodiment, based on FIG. 17, the reflector 3 of the MEMS vibrating mirror is changed from the original circular shape to a square shape, that is, the reflector frame 21 is changed from the original circular shape to a square shape, so that the chamber space of the outer frame 1 can be used to the maximum extent, thereby increasing the scanning range of the vibrating mirror. At the same time, the increase in the reflector frame 21 means that an effective area corresponding to the ground electrode GND and the steering electrode increases, so the steering electrode is correspondingly lengthened to both sides, thereby increasing its effective area. According to the above calculation formula for electrostatic adsorption force, a greater electrostatic adsorption force is obtained under the same driving voltage.

Specifically, the other film layer structures in FIGS. 23 to 27 refer to the aforementioned description of the structures shown in FIGS. 2 to 5, with the only difference being that the shapes of the reflector 3 and the reflector frame 21 are changed to square, and the length of the steering electrode is correspondingly increased, which will not be repeated here.

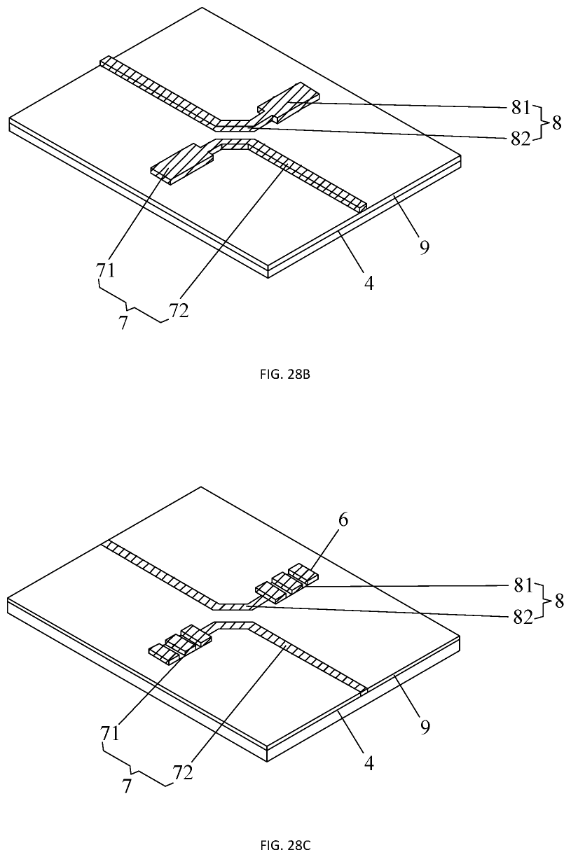

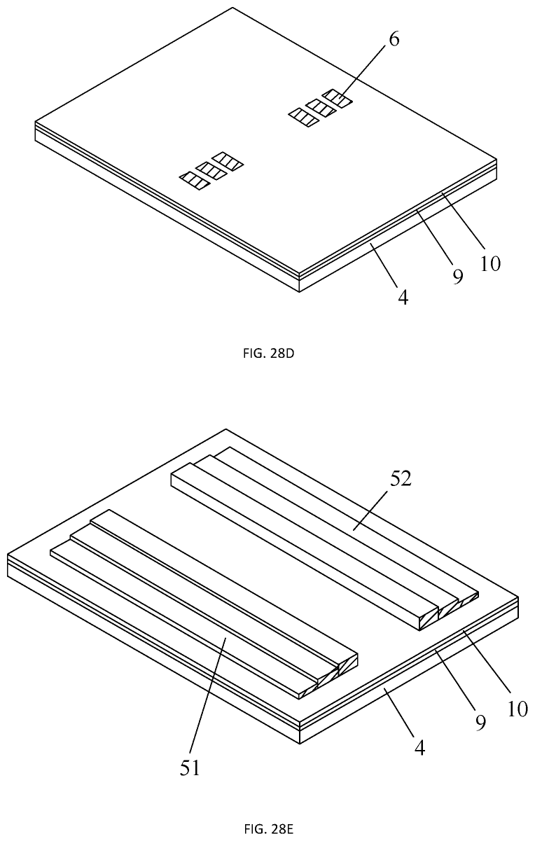

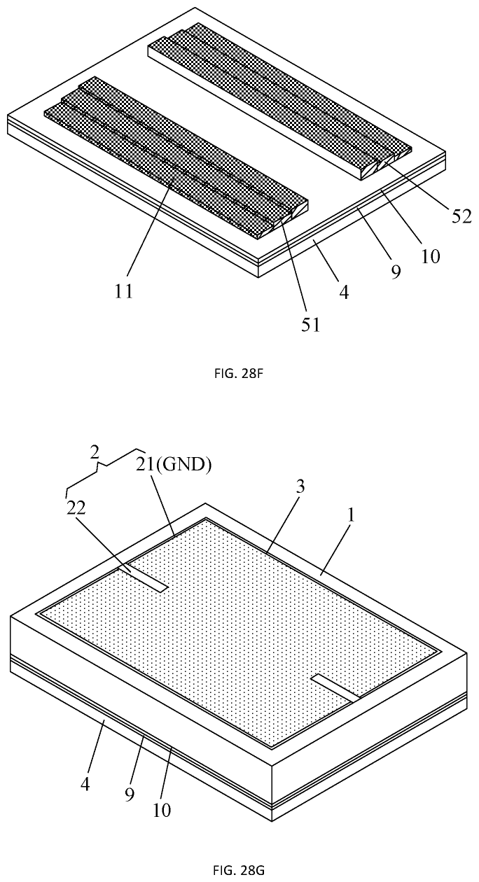

Specifically, the manufacturing process flow of the MEMS vibrating mirror shown in FIG. 23 can refer to the process flow shown in the aforementioned manufacturing process flow of FIG. 2, the difference being that a first isolation layer is deposited to cover the steering electrode group after the steering electrode group is manufactured, and when the outer frame 1 and the rotational structure 2 are manufactured, the reflector frame 21 is manufactured into a square shape and a pair of side edges of the reflector frame 21 have a concave structure, and the rotating shaft 22 is embedded in the concave structure and connected to the reflector frame 21. The manufacturing process flow chart of the MEMS vibrating mirror shown in FIG. 23 is shown in FIG. 28A-FIG. 28G and FIG. 23.

It should be noted that the first driving line 72 and the second driving line 82 in FIGS. 25 to 27 and the first driving line 72 and the second driving line 82 in FIGS. 4, 8 and 9 are connected to the step structure in the steering electrode at different positions, but have the same functions.

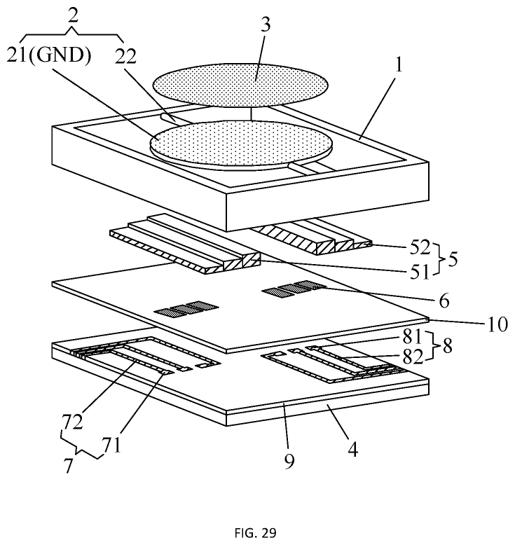

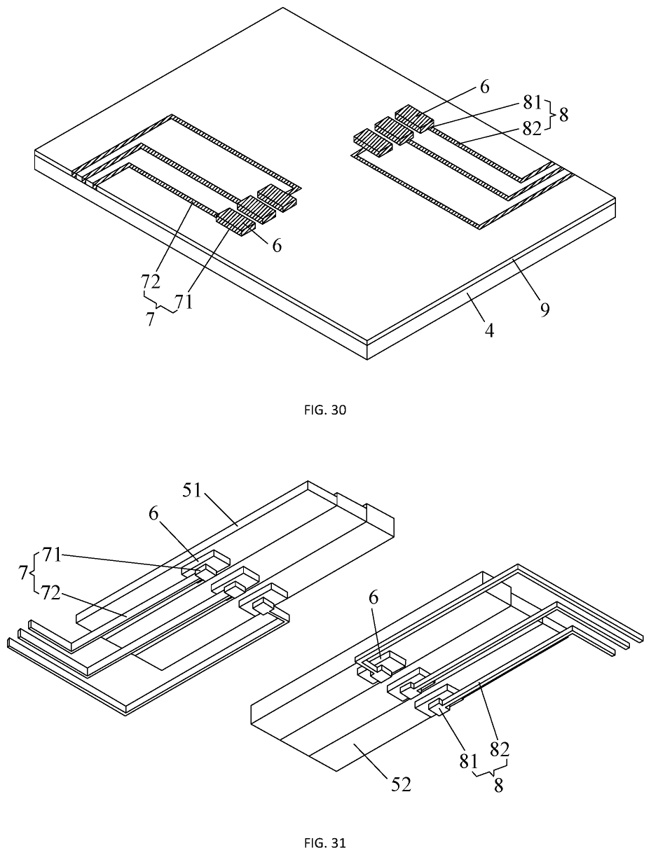

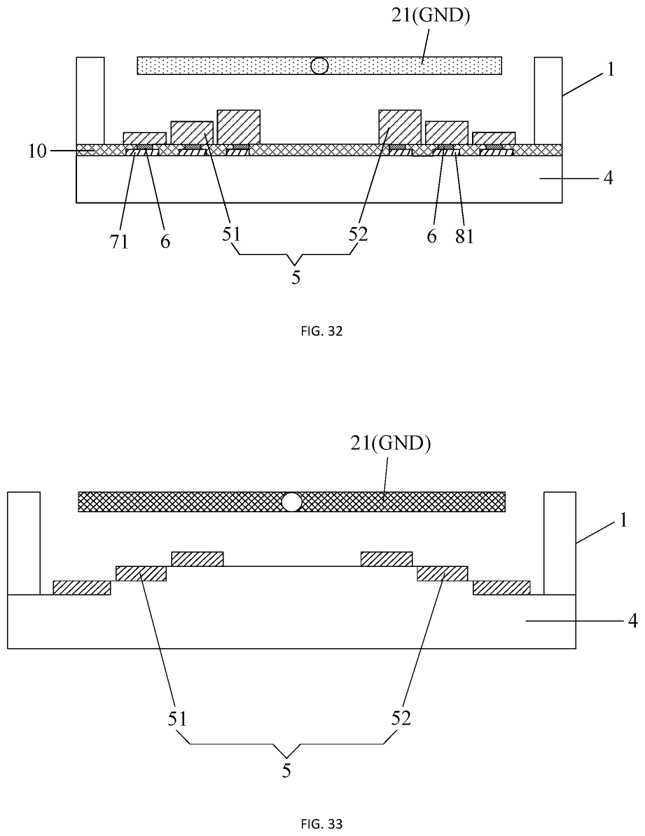

In specific implementations, in the above MEMS vibrating mirror provided in the embodiments of the present disclosure, as shown in FIGS. 29 to 32, FIG. 29 is an exploded schematic diagram of a structure of each layer of the MEMS vibrating mirror, FIG. 30 is a partial circuit connection structure diagram in FIG. 29, FIG. 31 is a partial circuit connection structure diagram in FIG. 29, and FIG. 32 is a cross-sectional schematic diagram of a partial structure in FIG. 29. The first driving structure 7 includes: first driving electrodes 71 electrically connected to the contact electrodes 6 corresponding to the first steering electrodes 51 in a one-to-one correspondence, and first driving lines 72 electrically connected to the first driving electrodes 71 in a one-to-one correspondence.

The second driving structure 8 includes: second driving electrodes 81 electrically connected to the contact electrodes 6 corresponding to the second steering electrodes 52 in a one-to-one correspondence, and second driving lines 82 electrically connected to the second driving electrodes 81 in a one-to-one correspondence. In this embodiment, the first driving electrodes 71 under the step structures of different thicknesses are changed from the original one-to-many (one first driving electrode 71 is connected to all corresponding step structures through the contact electrode 6) to one-to-one (one first driving electrode 71 is connected to a corresponding step structure through the contact electrode 6), and each first driving electrode 71 is electrically connected to a different first driving line 72, and the second driving electrodes 81 under the step structures of different thicknesses are changed from the original one-to-many (one second driving electrode 81 is connected to all corresponding step structures through the contact electrode 6) to one-to-one (one second driving electrode 81 is connected to a corresponding step structure through the contact electrode 6), and each second driving electrode 81 is electrically connected to a different second driving line 82. The wiring distribution of the driving structure is shown in FIGS. 30 and 31. Taking an example that each steering electrode includes three step structures, each steering electrode is divided into three steps of different thicknesses and connected to the driving electrodes below through the contact electrode 6 respectively. Other structural designs can still adopt the solutions of any of the embodiments in FIGS. 2 to 28G above. The specific structure is shown in FIG. 29. The MEMS vibrating mirror shown in FIG. 29 provided by the present disclosure adopts a multi-channel driving structure to connect step structures of different thicknesses in a one-to-one correspondence, and different power supply modes for the steering electrodes can be realized by powering with digital control signals.

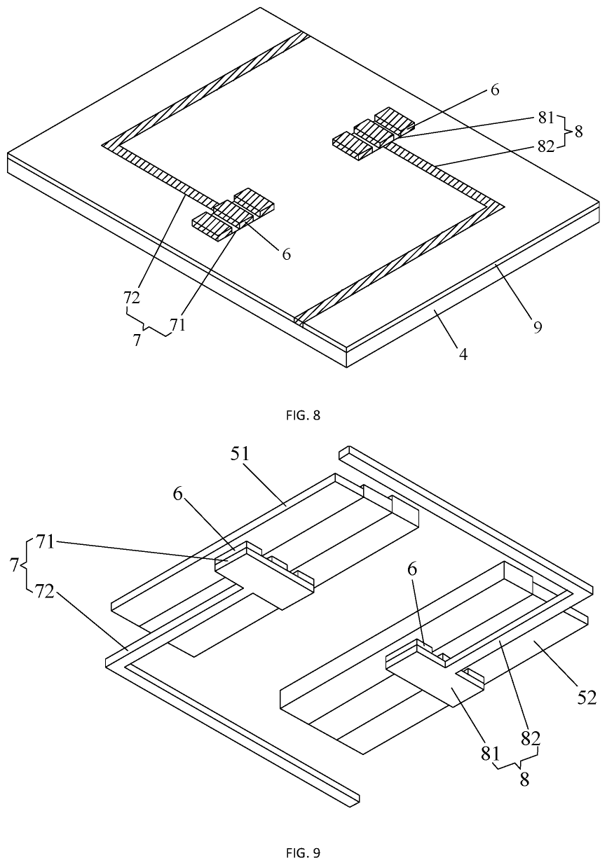

Specifically, compared to the single-channel control steering electrode shown in FIGS. 8 and 9, FIGS. 30 and 31 use digital signals to control the steering electrodes in multiple channels, which can not only achieve the same effect as FIGS. 8 and 9 by powering on at the same time, but can also determine the on and off of different step structures according to the torsion angle of the reflector. For example, when the reflector is not rotated, the thickest step structure with a smaller distance from the ground electrode is mainly driven. When the reflector is rotated by a certain angle, the thinnest step structure with a larger distance from the ground electrode is mainly driven, realizing various forms of free control. In addition, separately controlling the stepped steering electrodes can also reduce power consumption.

Specifically, the other film layer structures in FIGS. 29 to 32 refer to the aforementioned description of the structures shown in FIGS. 2 to 5, and the only difference is that the connection method between the first driving structure 7, the second driving structure 8 and the contact electrode 6 is changed, which will not be repeated here.

It should be noted that the MEMS vibrating mirrors shown in the aforementioned FIGS. 2 to 32 are all provided with stepped steering electrodes to reduce the distance between the ground electrode and the steering electrode, and other improvements are made on the basis of the stepped steering electrodes. Of course, in the specific implementations, in order to reduce the distance between the ground electrode and the steering electrode, there can also be other designs, for example, as shown in FIG. 33, FIG. 33 is a structural schematic diagram of another MEMS vibrating mirror provided in the embodiments of the present disclosure, the substrate 4 has at least two step structures with thicknesses gradually increasing from the outside to the inside of the reflector 3 at a position of the substrate 4 corresponding to each of the first steering electrode 51 and the second steering electrode 52, and the first steering electrode 51 and the second steering electrode 52 are arranged on the corresponding step structures. Specifically, the first steering electrode 51 and the second steering electrode 52 each include a sub-electrode(s) arranged corresponding to the step structure(s), and the thickness of each sub-electrode is the same, so that the same effect as the aforementioned FIGS. 2 to 32 can be achieved, and by designing a separately driven driving structure, multi-channel control of the steering electrode can be achieved, thereby reducing power consumption. According to the calculation formula for the electrostatic adsorption force:

$$F = \frac{ε {SV}^{2}}{2 {d}^{2}} ,$$

the electrostatic adsorption force is independent of the thickness of the steering electrode. Therefore, in this embodiment, a stepped substrate 4 is designed to replace the steering electrodes of different thicknesses in the previous embodiments, and then a layer of Cu metal is deposited on the substrate 4 and patterned to form a steering electrode. Similarly, a steering electrode with a different spacing from the ground electrode GND can be formed.

In specific implementations, the first steering electrode 51 in FIG. 33 can be an integral structure, and the second steering electrode 52 can be an integral structure, so that a single-channel control of the steering electrode can be achieved and the complexity of the driving structure design can be reduced.

In specific implementations, to manufacture the MEMS vibrating mirror shown in FIG. 33, firstly, a substrate 4 with a stepped gradient height is formed on a silicon substrate by multiple etchings, and then a layer of Cu metal is deposited to pattern a driving structure and a steering electrode with a certain gap. The process steps of the outer frame 1 and the rotational structure 2 are the same as those in the above embodiments. Finally, they are bonded together to form a MEMS vibrating mirror, and a reflector is formed on the reflector frame.

Specifically, the other film layer structures in the MEMS vibrating mirror corresponding to FIG. 33 refer to the aforementioned description of the structures shown in FIG. 2-FIG. 32, and the main difference lies in the different structures of the substrate 1 and the steering electrode, which will not be repeated here.

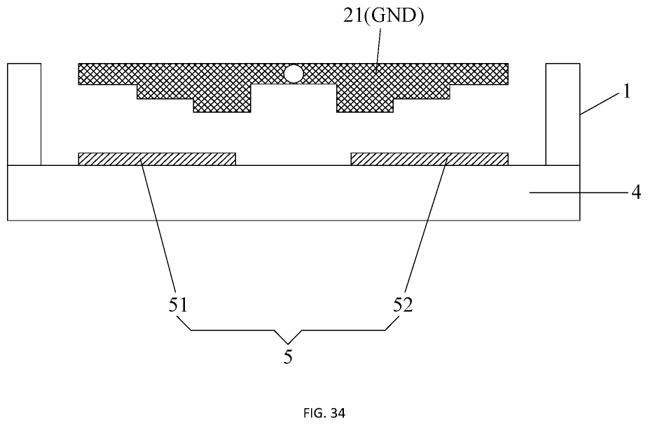

In the specific implementations, in order to reduce the distance between the ground electrode and the steering electrode, other designs can be used. For example, as shown in FIG. 34, FIG. 34 is a schematic diagram of a structure of another MEMS vibrating mirror provided in the embodiments of the present disclosure. The surface of the ground electrode GND facing the substrate 1 and positions of the ground electrode GND corresponding to the first steering electrode 51 and the second steering electrode 52 have at least two step structures with thicknesses gradually increasing from the outside to the inside of the reflector 3. In this embodiment, the steering electrode adopts a traditional flat structure, and the ground electrode GND is designed to be a step structure with a gradually decreasing distance from the outside to the inside with the steering electrode, which can also achieve the same effect as the aforementioned FIG. 2-FIG. 32. In terms of specific process steps, a traditional flat steering electrode structure is prepared on the substrate, and a stepped ground electrode GND as required in FIG. 34 is formed by multiple ICP etching techniques. Finally, a complete MEMS vibrating mirror is made through bonding, preparing a reflector, releasing a sacrificial layer and other process steps.

In the structure of the traditional flat reflector frame, the larger the size of the MEMS vibrating mirror is, the larger the moment of inertia of the reflector is, and the lower the resonant frequency is. The structure design of the MEMS vibrating mirror shown in FIG. 34 provided in the embodiments of the present disclosure can move the mass distribution of the reflector frame from both sides to the direction of the rotation axis, reducing the moment of inertia required for twisting the two sides of the reflector frame, that is, increasing the resonant frequency of the MEMS vibrating mirror.

In specific implementations, in the above MEMS vibrating mirror provided in the embodiments of the present disclosure, as shown in FIG. 34, the first steering electrode 51 can be an integral structure, and the second steering electrode 52 can be an integral structure. Of course, the first steering electrode 51 and the second steering electrode 52 each can also include sub-electrodes arranged corresponding to the respective step structures in the ground electrode GND, and each sub-electrode has the same thickness. In this way, single-channel control of the steering electrode and multi-channel control of the steering electrode can be achieved, and control can be performed according to actual needs.

Specifically, the other film layer structures in the MEMS vibrating mirror corresponding to FIG. 34 refer to the aforementioned description of the structures shown in FIG. 2-FIG. 34, and the main difference lies in the different structures of the ground electrode GND and the steering electrode, which will not be repeated here.

In specific implementations, in the above MEMS vibrating mirror provided in the embodiments of the present disclosure, as shown in FIG. 33 and FIG. 34, there is a gap between every two adjacent sub-electrodes in the first steering electrode 51 and the second steering electrode 52, and the setting of the gap is conducive to reducing the adhesion between the steering electrode and the ground electrode, thereby reducing the probability of the attraction phenomenon. Optionally, the gap width can be 6 μm to 10 μm, for example, the gap width can be 6 μm, 7 μm, 8 μm, 9 μm, 10 μm, etc.

In addition, the MEMS vibrating mirror provided in the embodiments of the present disclosure also has the following advantages.
1. The MEMS vibrating mirror provided in the embodiments of the present disclosure is an actively tunable one-dimensional MEMS vibrating mirror, which drives the rotation of the MEMS vibrating mirror through the electrostatic adsorption force generated between the ground electrode GND and the first steering electrode 51 or the second steering electrode 52. It has the characteristics of simple structure, small size and mature process of traditional electrostatically driven MEMS vibrating mirror.
2. The MEMS vibrating mirror provided in the embodiments of the present disclosure is only a simple improvement on the conventional MEMS vibrating mirror, and the implementation process is simple and the cost fluctuation is small.

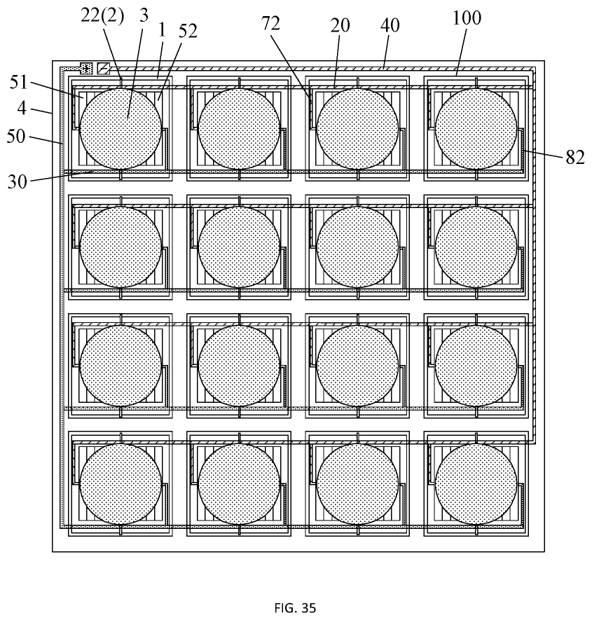

Based on the same inventive concept, the embodiments of the present disclosure also provide an MEMS vibrating mirror array, as shown in FIG. 35, including a plurality of MEMS vibrating mirrors arranged in an array as provided in the embodiments of the present disclosure. Specifically, the MEMS vibrating mirror array shown in FIG. 35 has the beneficial effects of the aforementioned MEMS vibrating mirrors, and when the MEMS vibrating mirror provided in the embodiments of the present disclosure is applied to a laser radar, the MEMS vibrating mirror array reflects the external laser beam, so that the laser radar can obtain a larger scanning range.

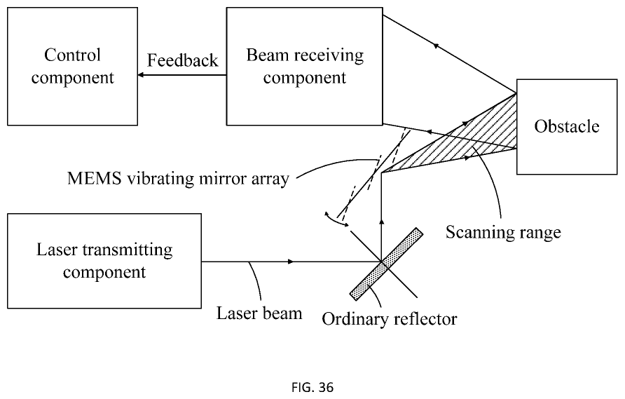

As shown in FIG. 36, FIG. 36 is a schematic diagram of the corresponding transmitting and receiving system when the MEMS vibrating mirror array provided in the embodiments of the present disclosure is applied to a laser radar. In a laser radar system composed of traditional optical reflectors, a larger torsion angle of the reflector is required to achieve a larger scanning range. However, the present disclosure adopts a plurality of groups of MEMS vibrating mirror arrays, and the maximum torsion angle of each MEMS vibrating mirror unit 100 does not change, but the MEMS vibrating mirror array can also achieve a larger scanning range. Moreover, the volume of the MEMS vibrating mirror realized by micromachining technology changes less and has a high degree of integration.

As shown in FIG. 35, in the embodiments of the present disclosure, the stepped MEMS vibrating mirror units 100 are periodically arranged to obtain an MEMS vibrating mirror array. The example given in this embodiment is a 4×4 array arrangement, but the actual application is not limited to this arrangement form, and different arrangement designs can be made according to actual needs.

In specific implementations, in the above MEMS vibrating mirror array provided in the embodiments of the present disclosure, as shown in FIG. 35, when the MEMS vibrating mirror adopts the circuit structure shown in FIG. 8, the first steering electrode 51 in each MEMS vibrating mirror corresponds to one first driving line 72, and the second steering electrode 52 in each MEMS vibrating mirror corresponds to one second driving line 82, and each first driving line 72 in each MEMS vibrating mirror is electrically connected to the same first driving voltage terminal (−), and each second driving line 82 in each MEMS vibrating mirror is electrically connected to the same second driving voltage terminal (+). Specifically, the first driving voltage terminal (−) is a negative AC voltage, and the second driving voltage terminal (+) is a positive AC voltage, and the AC voltage is loaded to the first driving voltage terminal (−) or the second driving voltage terminal (+) according to a preset deflection direction of the reflector 3. As shown in FIG. 35, the MEMS vibrating mirror array further includes a plurality of first wirings 20 and a plurality of second wirings 30 extending in a row direction and alternately arranged in a column direction, and a first wiring 20 and a second wiring 30 are correspondingly arranged on both sides of each row of vibrating mirror units 100 in the row direction; the MEMS vibrating mirror array further includes a plurality of third wirings 40 and a plurality of fourth wiring 50 arranged on the periphery of a plurality of vibrating mirror units 100; in the embodiments of the present disclosure, the first driving line 72 corresponding to each row of the plurality of vibrating mirror units 100 arranged in an array is electrically connected to the corresponding first wiring 20, and then all the first wirings 20 are electrically connected to the third wiring 40, and the third wiring 40 is electrically connected to the first driving voltage terminal (−); all the second driving lines 82 corresponding to the plurality of vibrating mirror units 100 arranged in an array are electrically connected to the corresponding second wiring 30, and then all the second wirings 30 are electrically connected to the fourth wiring 50, and the fourth wiring 50 is electrically connected to the second driving voltage terminal (+), so that in the present disclosure, all the first steering electrodes 51 are driven simultaneously by the same first driving voltage terminal (−), and all the second steering electrodes 52 are driven simultaneously by the same second driving voltage terminal (+), so that a larger scanning range can be obtained.

In specific implementations, in the above MEMS vibrating mirror array provided in the embodiments of the present disclosure, as shown in FIG. 35, when the MEMS vibrating mirror adopts the circuit structure shown in FIG. 30, the first steering electrode 51 in each MEMS vibrating mirror corresponds to a plurality of first driving lines 72 having the same number as the step structures, and the second steering electrode 52 in each MEMS vibrating mirror corresponds to a plurality of second driving lines 82 having the same number as the step structures, and each first driving line 72 in each MEMS vibrating mirror is electrically connected to the same first driving voltage terminal (−), and each second driving line 82 in each MEMS vibrating mirror is electrically connected to the same second driving voltage terminal (+). In this way, all the first steering electrodes 51 can be driven simultaneously by the same first driving voltage terminal (−), and all the second steering electrodes 52 can be driven simultaneously by the same second driving voltage terminal (+), so that a larger scanning range can be obtained.

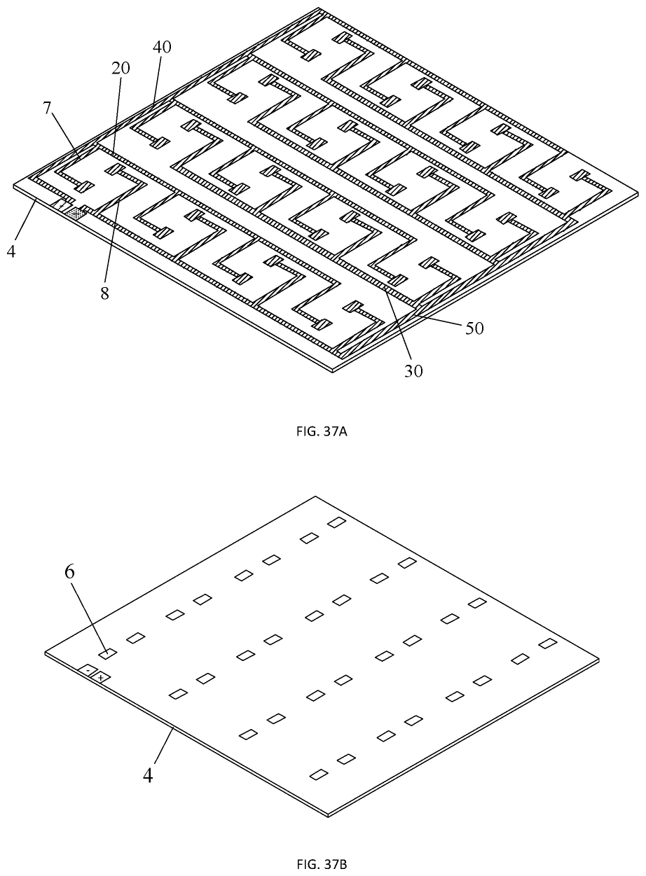

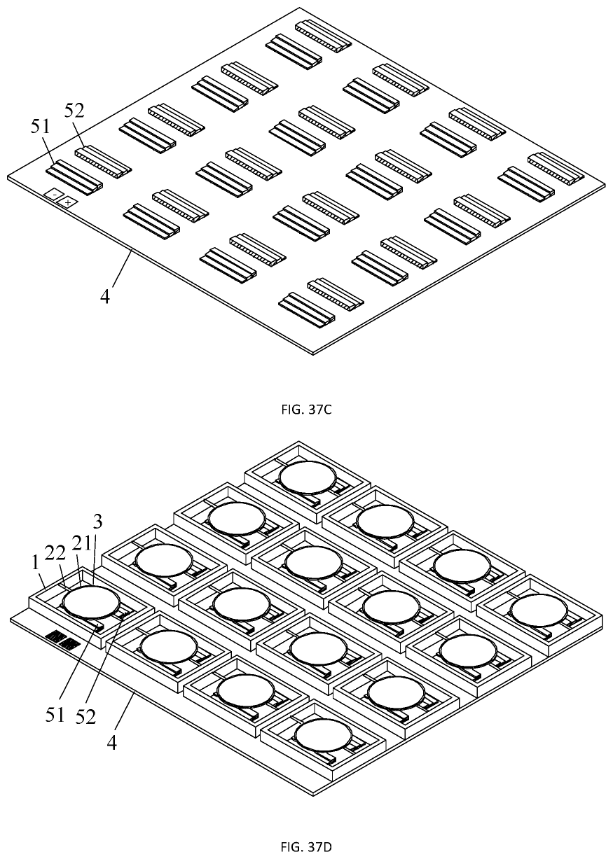

The manufacturing process of the MEMS vibrating mirror array shown in FIG. 35 is shown in FIG. 37A to FIG. 37D, and the basic process flow is the same as the manufacturing process of the MEMS vibrating mirror shown in FIG. 2, which specifically includes the following processes.
1. A first driving structure 7 and a second driving structure 8 as well as a first wiring 20, a second wiring 30, a third wiring 40, a fourth wiring 50, a first driving voltage terminal (−) and a second driving voltage terminal (+) are manufactured on a substrate 1 in an array distribution, as shown in FIG. 37A.
2. Based on FIG. 37A, a second isolation layer 9, a contact electrode 6, and a third isolation layer 10 in the manufacturing process of the MEMS vibrating mirror shown in FIG. 2 are manufactured in sequence. The third isolation layer 10 exposes the contact electrode 6, the first driving voltage terminal (−) and the second driving voltage terminal (+), as shown in FIG. 37B.
3. A first steering electrode 51 and a second steering electrode 52 in the manufacturing process of the MEMS vibrating mirror shown in FIG. 2 are manufactured on the basis of FIG. 37B, as shown in FIG. 37C.

Afterwards, the outer frame 1 and the rotational structure 2 in the manufacturing process of the MEMS vibrating mirror shown in FIG. 2 are manufactured, the substrate 4 and the outer frame 1 are bonded together, the sacrificial layer is filled in the hollow region, the reflector 3 is formed, and the sacrificial layer is removed, and the MEMS vibrating mirror array shown in FIG. 35 can be obtained, as shown in FIG. 37D.

In specific implementations, in the above MEMS vibrating mirror array provided in the embodiments of the present disclosure, when the MEMS vibrating mirror adopts the circuit structure shown in FIG. 30, the first steering electrode 51 in each MEMS vibrating mirror corresponds to a plurality of first driving lines 72 having the same number as the step structures, and the second steering electrode 52 in each MEMS vibrating mirror corresponds to a plurality of second driving lines 82 having the same number as the step structures.

The first driving line(s) corresponding to the step structure(s) located at the same position in each MEMS vibrating mirror is (are) electrically connected to the same first driving voltage terminal. For example, the first driving line(s) 72 corresponding to the step structure(s) with the smallest thickness in each MEMS vibrating mirror is (are) electrically connected to the same first driving voltage terminal (−), the first driving line(s) 72 corresponding to the step structure(s) with the middle thickness in each MEMS vibrating mirror is (are) electrically connected to the same first driving voltage terminal (−), and the first driving line(s) 72 corresponding to the step structure(s) with the largest thickness in each MEMS vibrating mirror is (are) electrically connected to the same first driving voltage terminal (−); the first driving line(s) corresponding to the step structure(s) located at different positions in each MEMS vibrating mirror is (are) electrically connected to different first driving voltage terminals, for example, the respective first driving lines 72 corresponding to the respective step structures with different thickness in each MEMS vibrating mirror are electrically connected to different first driving voltage terminals (−).

The second driving line(s) corresponding to the step structure(s) located at the same position in each MEMS vibrating mirror is (are) electrically connected to the same second driving voltage terminal. For example, the second driving line(s) 82 corresponding to the step structure(s) with the smallest thickness in each MEMS vibrating mirror is (are) electrically connected to the same second driving voltage terminal (+), the second driving line(s) 82 corresponding to the step structure(s) with the middle thickness in each MEMS vibrating mirror is (are) electrically connected to the same second driving voltage terminal (+), and the second driving line(s) 82 corresponding to the step structure(s) with the largest thickness in each MEMS vibrating mirror is (are) electrically connected to the same second driving voltage terminal (+); the second driving line(s) corresponding to the step structure(s) located at different positions in each MEMS vibrating mirror is (are) electrically connected to different second driving voltage terminals, for example, the respective second driving lines 82 corresponding to the respective step structures with different thicknesses in each MEMS vibrating mirror are all electrically connected to different second driving voltage terminals (+).

That is, the MEMS vibrating mirror array provided by the embodiments of the present disclosure can use digital signals to control the steering electrodes in multiple ways on the basis of achieving a larger scanning range. Not only can it be powered on at the same time to achieve the same effect as in FIG. 35, but it can also determine the on and off of different step structures according to the torsion angle of the reflector. For example, when the reflector is not rotated, the thickest step structure with a smaller distance from the ground electrode is mainly driven. When the reflector is rotated by a certain angle, the thinnest step structure with a larger distance from the ground electrode is mainly driven, thereby achieving various forms of free control. In addition, separately controlling the stepped steering electrodes can also reduce power consumption.

Based on the same inventive concept, the embodiments of the present disclosure further provide a radar system, including the above MEMS vibrating mirror of the embodiments of the present disclosure, or including the above MEMS vibrating mirror array of the embodiments of the present disclosure.

Optionally, the radar system may be a laser radar, as shown in FIG. 36, which includes a laser transmitting component, a beam receiving component, and an optical scanning component. The laser transmitting component is used to emit a laser beam; and the beam receiving component is used to receive an echo beam. The optical scanning component is the MEMS vibrating mirror in any of the aforementioned embodiments, which is used to reflect the laser beam and then irradiate the laser beam to the scanning environment, and reflect the echo beam reflected from the scanning environment to the beam receiving component.

The embodiments of the present disclosure provide an MEMS vibrating mirror, an MEMS vibrating mirror array and a radar system. When the ground electrode and the substrate are parallel, the distance between the first steering electrode and the ground electrode is set to gradually decrease from the outside to the inside of the reflector, and the distance between the second steering electrode and the ground electrode is set to gradually decrease from the outside to the inside of the reflector, that is, the distance between the first steering electrode and the ground electrode and the distance between the second steering electrode and the ground electrode are set to change in a step-by-step manner. Since the smaller the distance between the first steering electrode, the second steering electrode and the ground electrode is, the greater the capacitance is, the greater the electrostatic adsorption force between the first steering electrode, the second steering electrode and the ground electrode is, the electrostatic adsorption force can be increased by reducing the spacing between the steering electrode group and the ground electrode without reducing the maximum torsion angle of the reflector. In this way, under the condition of the same electrostatic adsorption force, the present disclosure can reduce the driving voltage and reduce the power consumption. In addition, when the ground electrode is deflected, due to the step-by-step change in distance, there are more gaps between the ground electrode and the first steering electrode or the second steering electrode, which is conducive to reducing the adhesion between the ground electrode and the first steering electrode or the second steering electrode, thereby reducing the probability of the attraction phenomenon.

Although the preferred embodiments of the present disclosure have been described, those skilled in the art can make additional changes and modifications to these embodiments once they have learned the basic creative concept. Therefore, the appended claims are intended to be interpreted as including the preferred embodiments and all changes and modifications falling within the scope of the present disclosure.

Obviously, those skilled in the art can make various changes and modifications to the embodiments of the present disclosure without departing from the spirit and scope of the embodiments of the present disclosure. Thus, if these modifications and variations of the embodiments of the present disclosure fall within the scope of the claims of the present disclosure and their equivalents, the present disclosure is also intended to include these modifications and variations.

1. A Miciro-Electro-Mechanical System (MEMS) vibrating mirror, comprising:
an outer frame, being a hollow structure;
a rotational structure, located in a hollow region of the outer frame, wherein the rotational structure comprises a reflector frame and a pair of rotating shafts connected between the reflector frame and the outer frame, and the reflector frame comprises a ground electrode;
a reflector, located on the reflector frame;
a substrate, wherein the substrate and the outer frame form a cavity; and
a steering electrode group, located on a side of the substrate facing the rotational structure, and the steering electrode group comprises a first steering electrode and a second steering electrode arranged on both sides of the pair of rotating shafts; wherein,
when the ground electrode and the substrate are parallel, a distance between the first steering electrode and the ground electrode gradually decreases from outside to inside of the reflector, and a distance between the second steering electrode and the ground electrode gradually decreases from the outside to the inside of the reflector.

2. The MEMS vibrating mirror according to claim 1, wherein a surface of the substrate facing the reflector is a flat surface, and the first steering electrode and the second steering electrode each comprise at least two step structures with thicknesses gradually increasing from the outside to the inside of the reflector, and each of the step structures serves as a sub-electrode.

3. The MEMS vibrating mirror according to claim 1, wherein the substrate has at least two step structures with thicknesses gradually increasing from the outside to the inside of the reflector at a position of the substrate corresponding to each of the first steering electrode and the second steering electrode, and the first steering electrode and the second steering electrode are arranged on corresponding step structures.

4. The MEMS vibrating mirror according to claim 2, wherein a first included angle is formed between an inclined surface formed by each steering electrode and the substrate, a second included angle is formed between the reflector frame and the substrate after the reflector frame being rotated at a maximum angle, and a degree of the first included angle is smaller than a degree of the second included angle.

5. The MEMS vibrating mirror according to claim 1, wherein the ground electrode has, on a surface of the ground electrode facing the substrate, at least two step structures with thicknesses gradually increasing from the outside to the inside of the reflector at a position corresponding to each of the first steering electrode and the second steering electrode.

6. The MEMS vibrating mirror according to claim 3, wherein the first steering electrode and the second steering electrode each comprise sub-electrodes arranged corresponding to the step structures, and a thickness of each of the sub-electrodes is the same.

7. The MEMS vibrating mirror according to claim 2, wherein a gap is provided between every two adjacent sub-electrodes in each of the first steering electrode and the second steering electrode.

8. The MEMS vibrating mirror according to claim 7, further comprising:
a first isolation layer, arranged on a side of the steering electrode group facing the ground electrode, wherein an orthographic projection of the first isolation layer on the substrate covers the substrate and the first isolation layer fills the gap.

9. The MEMS vibrating mirror according to claim 2, wherein a width of each of the step structures corresponding to the first steering electrode gradually increases from the outside to the inside of the reflector, and a width of each of the step structures corresponding to the second steering electrode gradually increases from the outside to the inside of the reflector.

10. The MEMS vibrating mirror according to claim 1, wherein the outer frame and the rotational structure are an integral structure formed using a silicon substrate, and the reflector frame is reused as the ground electrode.

11. The MEMS vibrating mirror according to claim 1, wherein the pair of rotating shafts are located on a same straight line and coincide with a central axis of the reflector, and the first steering electrode and the second steering electrode are symmetrically distributed on both sides of the central axis of the reflector.

12. The MEMS vibrating mirror according to claim 1, wherein a shape of the reflector is the same as a shape of the reflector frame, and a size of the reflector is the same as a size of the reflector frame.

13. The MEMS vibrating mirror according to claim 12, wherein the shape of the reflector comprises a circle or an ellipse, and the rotating shafts are connected to an outer annular surface of the reflector frame; and/or
wherein the shape of the reflector is square, a pair of side edges of the reflector frame have concave structures, and the rotating shafts are embedded in the concave structures and connected to the reflector frame.

14. (canceled)

15. The MEMS vibrating mirror according to claim 2, further comprising:
a plurality of contact electrodes, arranged between the steering electrode group and the substrate and arranged in a one-to-one correspondence with the step structures,
a first driving structure, arranged between the contact electrodes and the substrate and corresponding to the first steering electrode, and
a second driving structure, arranged between the contact electrodes and the substrate and corresponding to the second steering electrode; wherein,
the first steering electrode is electrically connected to contact electrodes corresponding to the first steering electrode, and the second steering electrode is electrically connected to contact electrodes corresponding to the second steering electrode;
the contact electrodes corresponding to the first steering electrode are electrically connected to the first driving structure, and the contact electrodes corresponding to the second steering electrode are electrically connected to the second driving structure.

16. The MEMS vibrating mirror according to claim 15, wherein
the first driving structure comprises: a first driving electrode electrically connected to all of the contact electrodes corresponding to the first steering electrode, and a first driving line electrically connected to the first driving electrode;
the second driving structure comprises: a second driving electrode electrically connected to all of the contact electrodes corresponding to the second steering electrode, and a second driving line electrically connected to the second driving electrode.

17. The MEMS vibrating mirror according to claim 15, wherein
the first driving structure comprises: first driving electrodes electrically connected, in a one-to-one correspondence, to the contact electrodes corresponding to the first steering electrode, and first driving lines electrically connected to the first driving electrodes in a one-to-one correspondence;
the second driving structure comprises: second driving electrodes electrically connected, in a one-to-one correspondence, to the contact electrodes corresponding to the second steering electrode, and second driving lines electrically connected to the second driving electrodes in a one-to-one correspondence;
wherein the MEMS vibrating mirror further comprises:
a second isolation layer, arranged between the contact electrodes and the first driving structure, and between the contact electrodes and the second driving structure, and
a third isolation layer, arranged between the contact electrodes and the steering electrode group;
wherein the second isolation layer exposes the first driving electrodes and the second driving electrodes, and the third isolation layer exposes the contact electrodes.

18. (canceled)

19. A Miciro-Electro-Mechanical System (MEMS) vibrating mirror array, comprising a plurality of MEMS vibrating mirrors according to claim 1 arranged in an array.

20. The MEMS vibrating mirror array according to claim 19, wherein
the first steering electrode in each of the MEMS vibrating mirrors corresponds to one first driving line or a plurality of first driving lines which are the same number as the step structures,
the second steering electrode in each of the MEMS vibrating mirrors corresponds to one second driving line or a plurality of second driving lines which are the same number as the step structures,
each first driving line in each of the MEMS vibrating mirrors is electrically connected to a same first driving voltage terminal, and
each second driving line in each of the MEMS vibrating mirrors is electrically connected to a same second driving voltage terminal.

21. The MEMS vibrating mirror array according to claim 19, wherein the first steering electrode in each of the MEMS vibrating mirrors corresponds to a plurality of first driving lines which are the same number as the step structures, and the second steering electrode in each of the MEMS vibrating mirrors corresponds to a plurality of second driving lines which are the same number as the step structures; wherein,
first driving lines corresponding to step structures at same positions in the respective MEMS vibrating mirrors are electrically connected to a same first driving voltage terminal, and first driving lines corresponding to step structures at different positions in the respective MEMS vibrating mirrors are electrically connected to different first driving voltage terminals;
second driving lines corresponding to step structures at same positions in the respective MEMS vibrating mirrors are electrically connected to a same second driving voltage terminal, and second driving lines corresponding to step structures at different positions in the respective MEMS vibrating mirrors are electrically connected to different second driving voltage terminals.

22. A radar system, comprising a Miciro-Electro-Mechanical System (MEMS) vibrating mirror, or comprising the MEMS vibrating mirror array according to claim 19,
wherein the MEMS vibrating mirror comprises:
an outer frame, being a hollow structure;
a rotational structure, located in a hollow region of the outer frame, wherein the rotational structure comprises a reflector frame and a pair of rotating shafts connected between the reflector frame and the outer frame, and the reflector frame comprises a ground electrode;
a reflector, located on the reflector frame;
a substrate, wherein the substrate and the outer frame form a cavity; and
a steering electrode group, located on a side of the substrate facing the rotational structure, and the steering electrode group comprises a first steering electrode and a second steering electrode arranged on both sides of the pair of rotating shafts; wherein,
when the ground electrode and the substrate are parallel, a distance between the first steering electrode and the ground electrode gradually decreases from outside to inside of the reflector, and a distance between the second steering electrode and the ground electrode gradually decreases from the outside to the inside of the reflector.
